(19) United States
(12) Patent Application Publication
(10) Pub. No.: US 2020/0290752 A1
(43) Pub. Date: Sep. 17, 2020

(54) AUTONOMOUS HANGING STORAGE, DOCKING AND CHARGING MULTIPURPOSE STATION FOR AN UNMANNED AERIAL VEHICLE

(71) Applicant: Igor M. Kolosiuk, Kiev (UA)

(72) Inventor: Igor M. Kolosiuk, Kiev (UA)

(21) Appl. No.: 16/816,218

(22) Filed: Mar. 11, 2020

Related U.S. Application Data
(60) Provisional application No. 62/816,274, filed on Mar. 11, 2019.

(51) Int. Cl. B64F 1/36; B64F 1/00; B64C 39/02; B64D 39/06; B60L 53/36; B60L 53/65; B60L 53/16

(52) U.S. Cl. CPC B64F 1/362; B64F 1/005; B64C 39/024; B64D 39/06; B60L 2200/10; B60L 53/65; B60L 53/16; B64C 2201/027; B60L 53/36

(57) ABSTRACT

Disclosed is an autonomous hanging storage, docking and charging multipurpose station (“the UAVMCS”) for unmanned aerial vehicles. The UAVMCS enables UAV to approach it, connect to it and fly into it from the bottom up. The UAVMCS is in the form of a cocoon in a closed state, and it is in the form of an umbrella in the open state. The system can be networked with a central control and a plurality of Unmanned Aerial Vehicles (“UAVs”).

The UAVMCS can include a base structure connected to a power grid, a station receiving assembly, a remote controller at the base structure enabled to communicate with a UAV and to initiate, control and stop docking and charging processes, a housing with covers, a positioning and stabilizing surface, and a UAV docking charging and refueling frame used for connecting to the docking housing unit. The UAVMCS can be mounted on towers, bridges, posts, electricity pylons, communication structures, buildings, and gas stations, but is not limited to them. The UAVMCS can serve as a UAV garage and as a place for storage of packages, as an outdoor lighting facility, and perform other functions.

### CROSS-REFERENCE TO RELATED APPLICATIONS

This application claims the benefit of U.S. Provisional Patent Application No. 62/816,274 filed on Mar. 11, 2019, the contents of which are hereby incorporated by reference in its entirety.

### TECHNICAL FIELD

One or more embodiments of the present disclosure generally relate to the autonomous work of an unmanned aerial vehicle (UAV). More specifically, one or more embodiments relate to the interaction of a charging device with a UAV within an unmanned aerial vehicle docking and charging multipurpose station (UAVMCS), and client-server software.

### BACKGROUND

The UAV market is in the infancy stage although it has been rapidly growing over the last few years. Aerial photography and videography are becoming increasingly common in providing images and videos in various industries. Typically, UAVs are remote controlled, thus necessitating an operator to control the movements of UAVs. This becomes problematic, however, when the UAV is deployed over harsh terrain (e.g., mountains) or over large areas of land.

In some circumstances, a UAV operator does not need to be within the viewing range of the UAV. For example, some conventional UAVs provide an operator real-time video captured from the UAV for long-range remote control of the UAV. In a long-range remote-controlled scenario, however, additional problems arise with conventional UAVs and conventional UAV systems. For example, long-range remote-controlled scenarios often include the need to remotely land a UAV (e.g., in order to recharge the battery). The remote landing process for an operator, however, is often difficult and error-prone, which increases the probability of damaging or destroying a UAV, resulting in considerable expense. In addition, a damaged UAV can delay a project, causing additional down-time and expense.

In the near future, drones will be widely used in traditional economic sectors as well as for supporting emerging technologies. One of the most promising applications of UAV is delivery service because of the logistic, economic and environmental benefits it creates.

The main application problem is the limited flying range and, consequently, the need of performing a lot of battery recharging during the time interval a drone performs its task.

Any approach to docking a UAV for battery recharging at a station imposes the requirement of accurate positioning. Besides necessary position-detection equipment and techniques, there are other significant issues to be considered, such as weather conditions or vandals. These factors increase the complexity of the docking and charging systems.

Accordingly, there are a number of considerations to be made in docking UAVs.

### SUMMARY OF THE EMBODIMENTS

The principles described herein provide the benefits and/or solve one or more of the foregoing or other problems in the art with systems and methods that enable the autonomous docking of a UAV. In particular, one or more embodiments described herein include systems and methods that enable a UAV to conveniently interface with and dock within an autonomous docking, recharging, refueling and storing multipurpose station (the UAVMCS). For example, one or more embodiments include a station and docking charging and refueling frame that interface with the docking housing unit of a UAVMCS in a manner that allows the UAV to automatically dock with accuracy.

Furthermore, in one or more embodiments, systems and methods features are included that cause the UAV to guide itself to a docking housing unit of the UAVMCS. For instance, the UAV can include a docking charging and refueling frame having a complementary shape to the shape of the UAVMCS receiving assembly. When the UAV comes into contact with the UAVMCS, the shape of the station and/or the docking housing unit can enable the UAV to self-align within the UAVMCS as the UAV docks within the docking housing unit of the UAVMCS. As such, the UAV can safely dock within the UAVMCS with minimal error and without substantial risk of damaging or destroying the UAV during UAV docking.

Furthermore, one or more embodiments, systems and methods include features and functionality that facilitate charging a power source within the UAV when the UAV docks within the UAVMCS. For example, the UAV can include charging contacts that couple to charging contacts in the UAVMCS when the UAV docks within a docking housing unit of the UAVMCS. When the UAV charging contacts are in contact with the UAVMCS charging contacts, the UAVMCS can charge the battery of the UAV.

Furthermore, one or more embodiments, systems and methods include features and functionality that facilitate refueling a fuel tank of the UAV or refilling the tank for specific liquids which is mounted on the UAV when the UAV docks within the UAVMCS. For example, the UAV can include refueling pipe, retractable rod for filling or pouring cargo into the UAV connects with the upper suspension of the UAV, electromagnetic, vacuum or otherwise. After combining these two parts, liquid or bulk cargo or fuel is supplied from the docking housing unit to the UAV or vice versa. After the process of refueling, recharging, pouring is finished, the undocking occurs in the reverse order.

The present invention has been made in an effort to provide an autonomous charging station for an unmanned aerial vehicle that is hanging and capable of docking to UAVs from the bottom up, or in any other manner without any limits.

The present invention has also been made in an effort to provide a UAVMCS that can comprise in an enclosure in the form of a cocoon, parasol or an open umbrella, which enables easier positioning and docking for the UAV, and which protects the station from weather influence and vandals.

An exemplary embodiment of the invention represents one of the examples of enclosure which comprises a rigid metal framework being a combination of hard material elements and soft parts made of a dense waterproof fabric, but not limited to it. The exemplary embodiment of structure is folding and may have two or more states: for instance, in the first state, the closed one, the structure generally may be in the form of a cocoon, and when it unfolds in the second state, an open one, it may have the form of an open umbrella.

The internal part of the UAVMCS may comprise a docking housing unit, a power supply, one or more electrical contact regions, a control module having a processor and memory, one or more remote controllers, a positioning and ensuring surface, a receiving assembly with camera and sensors, a connector inside the docking housing unit as well as a locking and charging mechanism in it, which is used to grab and lock the docking charging and refueling frame of the UAV to establish connection between the UAVMCS and a UAV, a communication module with a GPS aerial, an altitude indicator, a gyroscope, an inertial navigation system, a gimbal, a laser rangefinder, a GPS retranslator, a calibration system, a station remote controller, a cooling system, and a heating system. One or more electrical contact regions are electrically coupled to an electrical power supply. One or more electrical contact regions are configured to provide wired charging, wireless charging, or both to UAV.

These and additional features provided by the embodiment described herein will be more fully understood in view of the following detailed description, in conjunction with the drawings.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

In order to describe the manner by which the above-stated and other advantages and features of the embodiments can be obtained, a more particular description of the principles briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, principles will be described and explained with additional specificity and detail through the use of the accompanying drawings.

The detailed description is described with reference to the accompanying figures. In the figures, the leftmost digit(s) of a reference number identifies the figure in which the reference number first appears. The use of the same reference numbers in different figures indicates similar or identical components or features.

FIG. 1A depicts a side-perspective view of the UAV positioning-detection equipment and techniques, synchronization of the UAVMCS, the UAV and an external system. Particularly, an example of the UAVMCS upper part is depicted with petals design and construction of soft materials.

FIG. 1B depicts a side-perspective view of the UAV positioning-detection equipment and techniques, synchronization of the UAVMCS, UAV and external system parameters. In this instance, an example of the UAVMCS upper part is depicted with petals design and construction of hard materials.

FIG. 1C depicts a side-perspective view of the UAVMCS. In this instance, an example of the docking housing unit of the UAVMCS is depicted in the form of hexagonal pyramid constructed of hard materials.

FIG. 1D illustrates a schematic diagram showing an exemplary embodiment of the autonomous docking charging system 1000.

FIG. 2A depicts a side-perspective view of the open state and the close state of an example of the enclosure of the UAVMCS comprised an all-weather protective covers designed and constructed of soft materials, in accordance with examples of the present disclosure.

FIG. 2B depicts a side-perspective view of the open state and the closed state as an example of the enclosure of the UAVMCS comprised a primary flat wide parts designed and constructed of hard materials, in accordance with examples of the present disclosure.

FIG. 2C, FIG. 2D and FIG. 2E depict an example of the UAV positioning, docking and fixing for charging and storing steps of the process of directing and docking the UAV to the station, and recharging or refueling or both the UAV.

FIGS. 3A and 3B depict an example of the open position of the enclosure and the docking housing unit of the UAVMCS with a side-lengthwise cutaway drawing and the UAV approaching for docking, and an example of the closed state of the enclosure and the docking housing unit of the UAVMCS with a lengthwise cutaway drawing, and the UAV being fixed in the charging, diagnostics and storage position.

FIG. 4A depicts a schematic diagram of the arrangement of elements of the docking housing unit and the enclosure of the UAVMCS with a lengthwise cutaway drawing in the closed state and the UAV hanging for docking, diagnostic, storage, charging or refueling in accordance with examples of the present disclosure.

FIG. 4B depicts the other example of the schematic diagram of the arrangement of elements of the docking housing unit of the UAVMCS with a lengthwise cutaway drawing and the UAV reaching the docking housing for hanging, further docking, diagnostic, storage or charging, in accordance with examples of the present disclosure.

FIG. 5 depicts an example of the schematic diagram of the refueling and refilling the tank of the UAV with fuel or liquids or both by using docking housing unit of the UAVMCS in accordance with examples of the present disclosure.

FIG. 6 depicts an example of the schematic diagram of the example of the positioning more than one docking housing units of the UAVMCS thereby constructing a flat or surface for charging and storing. The flat or surface is formed by several docking housing units in the form of hexagonal pyramid, but not limited to the form, that can make a charging platform with several, not limited by quantity, charging and storing points. The surface enables getting different types of drones for recharging, storing, refilling.

FIG. 7 depicts an example of schematic diagram of the lower suspension mechanism which in one or more examples could be mounted on the UAV for enabling the UAV perform cargo delivery, pick up and drop off missions.

FIG. 8A depicts an example of the load positioning member for picking up and fixing a cargo, enabling removal/detachment/drop off from the lower suspension mechanism of the UAV without any outside help or involving people, mechanisms, robots.

FIG. 8B depicts an example of schematic diagram of precise positioning of the UAV in the process of targeting the load positioning member by UAV lower suspension mechanism or hook or the capture device but not limited to these types of load picking up mechanisms.

FIG. 8C depicts an example of schematic diagram of grabbing the load using an one or more embodiment of the lower suspension mechanism of the UAV directing to the load positioning member for gripping, picking up the cargo, in this example the load positioning mechanism presented as loop in the shape of an ‘8’, but not limited to it.

FIG. 8D depicts an example of schematic diagram of using a one or more embodiment of the tripod for hanging one or more load positioning member with the hanging cargo, or another device that enables securing of the load positioning member and a load in any way. The tripod can be equipped with the necessary accurate positioning sensors or ID tags or both for the UAV. The tripod can be equipped with special mechanisms, devices for securing load and load positioning member of any form.

FIG. 9A depicts an example of a side view of the embodiment of a modern outdoor light pole construction performing outdoor lighting with the example of the docking housing unit and the docking housing unit with enclosure of the UAVMCS mounted on it.

FIG. 9B depicts an example of a side-perspective view of the example of the docking housing unit and the docking housing unit with enclosure of the UAVMCS mounted under a bridge.

FIG. 9C depicts examples of a side-perspective view the example of the docking housing unit and the docking housing unit with enclosure of the UAVMCS as mounted on bridges, gas station pylons, and buildings, in accordance with examples of the present disclosure.

FIG. 10 depicts an example of an infrastructural application of the combination of one or more examples of the docking housing unit of the UAVMCS and an example of a logistic center, equipped with the application of several docking housing units of the UAVMCS.

FIGS. 11A, 11B, 11C depict a simplified flowchart or a series of actions showing methods of autonomously docking a UAV in accordance with one or more embodiments.

### DETAILED DESCRIPTION OF SPECIFIC EMBODIMENTS

Examples of the present disclosure relate generally to unmanned aerial vehicles, and especially to a system of docking stations for UAVs. The docking stations may incorporate a number of features to enable unmanned aerial vehicles to fly longer routes, to fly routes more accurately, and to provide safe enclosure during adverse conditions. In some examples, the docking stations may also provide additional services to the communities in which they are installed. By way of example, the UAVMCS can also include various package handling abilities to facilitate delivery services such as groceries, mail, coffee, and other items. In other examples, the UAVMCSs may be networked to provide infrastructure for command and control for the UAV operations and missions.

The vehicles, methods, and systems described hereinafter as making up the various elements of the present disclosure are intended to be illustrative and not restrictive. Many suitable vehicles, energy sources, navigational aids, and networks that would perform the same or a similar function as the system described herein are intended to be embraced within the scope of the disclosure. Such other systems and methods not described herein can include, but are not limited to, vehicles, systems, networks, and technologies that are developed after the time of the development of the disclosure.

As mentioned above, a limiting factor with current UAV technology is the relatively short range available when a UAV is carrying a heavy of large payload. In other words, while the UAV may have a range of several, or even tens of miles unladen, this range can drop to less than a mile while carrying a package. Of course, larger UAVs with larger payloads and ranges are available, but the tradeoff between range and payload remains a significant concern in UAV system design.

The term “unmanned aerial vehicle” (“UAV”), as used herein, generally refers to an aircraft that can be piloted autonomously or remotely by a control system. For example, a “drone” is a UAV that can be used for multiple purposes or applications (e.g., military, agriculture, surveillance, delivery, etc.). In one or more embodiments, the UAV includes onboard computers that control the autonomous flight of the UAV. In at least one embodiment, the UAV is a multi-rotor vehicle, such as a quadcopter, and includes a carbon fiber shell, integrated electronics, a battery bay (including a battery assembly), a global positioning system (“GPS”) receiver, a fixed or removable device with imaging capability (e.g., a digital camera), and various sensors or receivers. The UAV can also include a computing device including programmed instructions that allow the UAV to start-up, fly in, fly out, and dock autonomously.

The term “autonomous docking, recharging, refueling and storing multipurpose station” (“the UAVMCS”), as used herein, generally refers to an apparatus from which a UAV can fly out, and where the UAV can later dock into and be stored until its next flight. For example, the UAVMCS can include docking housing unit for UAV storage, whose function it is to act as a charging area for the UAV while it is being stored. In at least one embodiment, following the autonomous docking of the UAV, one or more systems of the UAVMCS can recharge one or more batteries of the UAV, refuel one or more tanks of the UAV, download data (e.g., digital photographs, digital videos, sensor readings, etc.) collected by the UAV. In one or more embodiments, the UAVMCS allows wireless communication between the UAVMCS and a server to transfer data collected by the UAV and download the data to the UAVMCS or to the server. In some examples, the UAV 102 can also include a camera. The camera can be, for example, a standard video camera, an infrared camera, a night vision camera, sonar receiver, radar receiver or other cameras and their elements. The camera can enable the UAV 102, for example, to locate the UAVMCS, align with the package handling system, and recharge and/or refuel. In some examples, the camera can also provide a remote access to a video feed to monitor weather and light conditions, suspicious and criminal activity, traffic conditions, and other information. In some examples the UAVMCS can be comprised of image and action recognition modules, which can use the feed to perform various images and video analyses.

One or more embodiments described herein include an autonomous docking, recharging, refueling and storing multipurpose station for the UAV. For example, the UAVMCS described herein manages an autonomous docking, charging, refueling, and storage of a UAV. The UAVMCS described herein includes components that enable a UAV to autonomously dock, charge, and fuel within the station. For example, in one or more embodiments, the autonomous hanging docking and charging system (“System”) includes one or more UAVMCS, it can include one or more UAV's having a main body and a UAV docking charging and refueling frame coupled to the main body and client-server software, which can include a number of services to facilitate UAV guidance and maintenance and community acceptance, and also can include navigational aid to guide the UAVs to the UAVMCS and to provide routing information from the central control. The UAVMCS can include package handling facilities and can act as a final destination or as a delivery hub, it can extend the range of UAVs by providing recharging/refueling stations for the UAVs. Also, the UAVMCS can be incorporated into existing infrastructure, such as bridges, poles, buildings, etc. and can comprise standalone structures to provide additional services to underserved areas. For example, to encourage municipalities, local communities, and individuals to install UAVMCS, the UAVMCS stations may also include a number of mutually beneficial features. For example, the UAVMCS may perform different functions, including but not limited to, monitoring, surveillance, and control over property, information and advertising services, news gathering, such as weather and traffic conditions, distribution of goods and services, dissemination of all kinds of signals, e.g. the internet, and others. Some UAVMCS may perform power supply functions by producing energy using available power supplies comprising solar power supply, wind power supply, and other alternative power sources.

The client-server software can choose the route, delivery time, and weather conditions, among other things. The client-server software central control can generate a flight plan, comprised of one or more segments, for chosen UAV. The flight plan can be chosen based on current wind and weather conditions, delivery time, UAV flight speed, among other things.

The client-server software central control can then ensure that flight plan segments do not exceed the maximum range of chosen UAV. In other words, if the UAV has sufficient range to the final destination, the UAV can fly directly to the final destination.

If any of the flight segments do exceed the maximum range of the UAV 102, on the other hand, the client-server software central control can add segments and stops at intervening UAVMCS, as necessary. The UAVMCS can enable the UAV to dock, recharge, refuel, and then continue along the flight path to the final destination. When a sufficient number of intervening UAVMCS have been added to the flight plan to provide sufficiently short flight segments, the flight plan can be sent to the UAV 102 for execution.

In some cases, the flight plan may need to be modified to account for changing weather conditions. As result, examples of the present disclosure can also comprise a method for rerouting UAV to avoid significant weather issues. This can enable the system to identify localized weather events such as, for example, thunderstorms, which tend to be fairly small and localized, but violent. If, on the other hand, the weather event exceeds the predetermined threshold, the client-server software central control can generate an alternative plan in an attempt to avoid the weather event. If, for example, the weather event is a fairly localized thunderstorm, the system can simply route the UAV around the weather event. If the weather event can be avoided, an alternative flight plan can be sent to the UAV for execution.

If, on the other hand, the weather event is more widespread, it may be impossible or impractical for the client-server software central control to route the UAV around the weather event. In this case, the client-server software central control can determine the current location of the UAV, and then determine the location of the closest UAVMCS to the current location. In some examples, this can comprise the closest available UAVMCS. The client-server software central control can send a “hold” flight plan to the UAV to fly to the closest UAVMCS and hold for the weather to clear. In some examples, the UAV can take advantage of the UAV securing system at UAVMCS to prevent damage during the weather event.

In still other examples, the UAVMCS can be mounted on existing infrastructure or, for example, installed in public parks, buildings, sightseeing points, and other public areas. In this manner, the service provider can offer additional services to community, government entities, and individuals through applying the features of client-server software, for example, to sharing the UAV 102 for video recording, photo sessions and other events. In some examples, the innovative features of UAV technology can be applied to users, for example, following objects, image recognition, inspections, 3D mapping, and other services.

The location of stations in parks allows the service provider to provide additional services for leasing a drone for the community or an individual to record short video clips, photo sessions using the effects of following the object, including filming events, weddings, corporate trainings, etc.

The client-server software for controlling one or more UAVs to respond to a request for information, is comprised of, but not limited to one or more processors, one or more non-transitory storage mediums, which when implemented cause the client-server software to perform, for example, the steps of: receiving a natural language request for information about a spatial location; parsing a natural language request into a plurality of requests, with data corresponding to a portion of data necessary to answer the natural language request; configuring a flight plan for one or more UAVs based on the plurality of data requests; controlling one or more UAVs to fly over the location according to the configured flight plan; extracting data responsive to the plurality of data requests obtained by one or more drones; and analyzing the responsive data to provide an answer to the natural language request for information.

The client-server software further comprising program instructions which cause the system to perform, for example, the steps: uploading flight plan to the one or more UAVs; receiving real-time telemetry from the UAV; performing analytics on the real-time telemetry to determine real-time flight conditions and displaying real-time telemetry and real-time conditions on a user interface (UI) in a mobile application or other client interface.

In still other examples, the client-server software can track and control the plurality of the UAVs 102. For example, the client-server software control module can communicate with the UAV 102 and/or the access door sending a signal to the access door to open and close when the UAV approaches it as well as the control module of the UAV can interact or communicate with the docking charging unit of the UAVMCS to control the positioning process for further docking, charging, refueling or storing of the UAV.

In one or more embodiments, the system includes a self-aligning interface that enables a UAV to conveniently and accurately connect and dock within the docking housing unit. For example, in one or more embodiments, the UAV can include a UAV docking charging and refueling frame having a shape that is complementary to a shape of the receiving assembly of the docking housing unit. For example, in one or more embodiments, the docking housing unit includes a conical bearing surface that makes contact with a complementary shaped docking charging and refueling frame of the UAV. As a result, when the UAV is docking and making contact with the docking housing unit, the docking charging and refueling frame of the UAV can be self-aligned within the receiving assembly of the docking housing of the docking housing unit.

In addition to facilitating alignment of the UAV with respect to the docking housing unit, the UAVMCS further includes one or more features that enable a battery on the UAV to be charged when the UAV is within the docking housing unit. For example, the UAVMCS can provide a convenient charging interface between the UAV and the UAVMCS. In one or more embodiments, the UAVMCS charges a battery or other power source on board of the UAV when one or more charging contacts on the UAV couple to one or more corresponding docking housing unit charging contacts. Additionally, the arrangement of contacts on both the UAV and the docking housing unit can facilitate a connection between the UAV and the docking housing unit that provides an electrical current that passes between particular nodes of a battery assembly and charges the battery onboard the UAV. As such, the UAVMCS can enable convenient charging of a battery when the UAV is within the docking housing unit.

More particularly, the docking housing unit can include an arrangement of charging contacts within the docking interface that causes one or more charging contacts of the UAV to automatically align with and couple to corresponding contacts within the docking housing unit upon docking of the UAV within the docking housing unit. For example, in one or more embodiments, the UAV includes a plurality of charging contacts positioned on the UAV docking charging and refueling frame. Additionally, the docking housing unit can include one or more charging contacts. In one or more embodiments, the arrangement of the charging contacts on the UAV can ensure that the charging contacts on the UAV couple to a corresponding docking housing unit charging contacts when the UAV docks within the docking housing unit. Additionally, the arrangement of the charging contacts on the UAV can ensure that a particular subset of charging contacts on the UAV couple to corresponding docking housing unit charging contacts when the UAV docks within the docking housing unit. As such, charging contacts on the UAV and the docking housing unit can automatically align and establish an electrical connection between the UAV and the docking housing unit.

In addition, energy sources could also be a number of other types such as, a fuel cell, a solar storage system, or a capacitor. In addition, there are myriad types of batteries and the battery packs can comprise a variety of different battery types including, but not limited to, lithium ion, nickel cadmium, nickel metal hydride, lithium polymer, and combinations thereof. The use of a capacitor, for example, can enable the battery pack to be recharged quickly obviating the need for multiple battery packs. In addition, while a conventional contact type battery charger is discussed, other types of chargers such as, inductive, RF, and other non-contact charging systems are contemplated herein.

In addition to facilitating alignment of the UAV with respect to the docking housing unit and charging the UAV battery, the UAVMCS further includes one or more features that enable a tank on the UAV to be refueled when the UAV is within the docking housing unit. For example, the UAVMCS can provide a convenient fueling interface between the UAV and the UAVMCS. In one or more embodiments, the UAVMCS fills a tank or other container with a liquid when one or more filler tubes on the UAV couple to one or more corresponding docking housing unit fueling contacts. Additionally, the arrangement of contacts on both the UAV and the docking housing unit can facilitate a connection between the UAV and the docking housing unit that enables a liquid to pass from a container on the UAVMCS through the docking charging and refueling frame of the UAV to the tank onboard the UAV. As such, the UAVMCS can enable convenient refueling of a tank when the UAV is within the docking housing unit. Finally, UAVMCS may be configured to enable multiple UAVs to be refueled/recharged at the same time.

In other examples, the UAVs may comprise a refueling docking charging and refueling frame engageable with a refueling nozzle on the docking housing unit of the UAVMCS. The refueling nozzle, in turn, can transfer fuel to the storage tank in the docking housing unit of the UAVMCS (or somewhere on the docking station), or transfer liquids for spray or other applications. In some examples, the refueling docking charging and refueling frame of the UAV may be comprised of a cone-shape or cylindrical-shaped tube or pipe to ensure the maneuvering accuracy required by the UAV 102. When the UAVs 102 dock within the UAVMCS, the refueling docking charging and refueling frame of the UAV can engage with the refueling nozzle of the docking housing unit of the UAVMCS to enable the system to refill the fuel or other liquid storage tank.

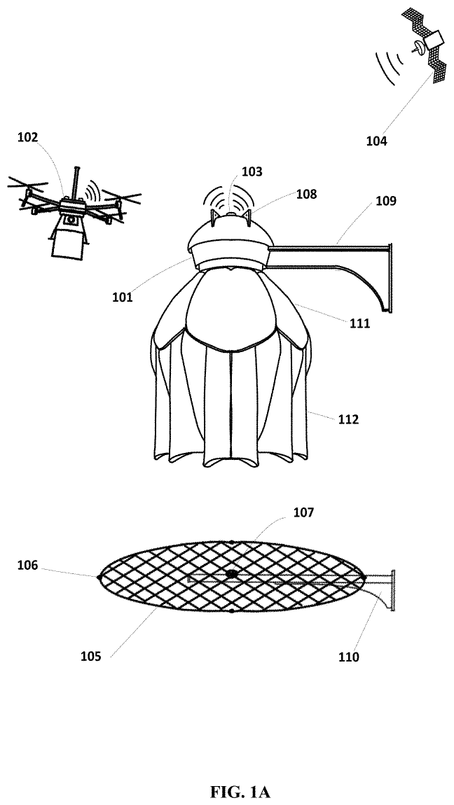

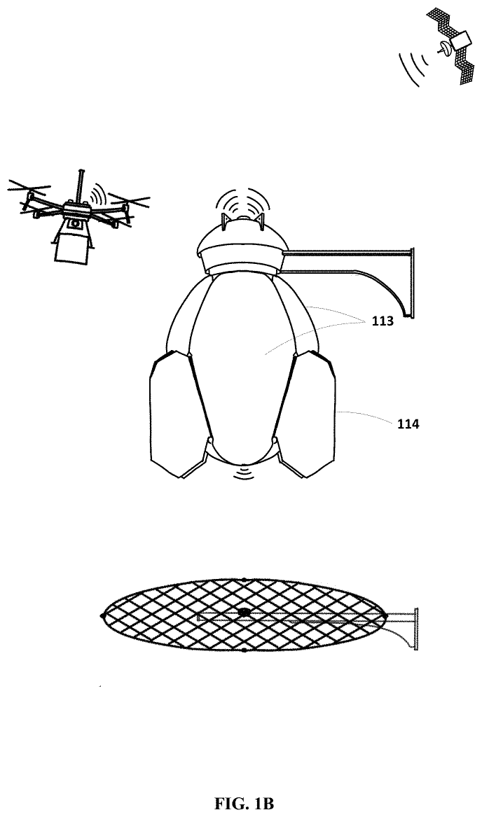

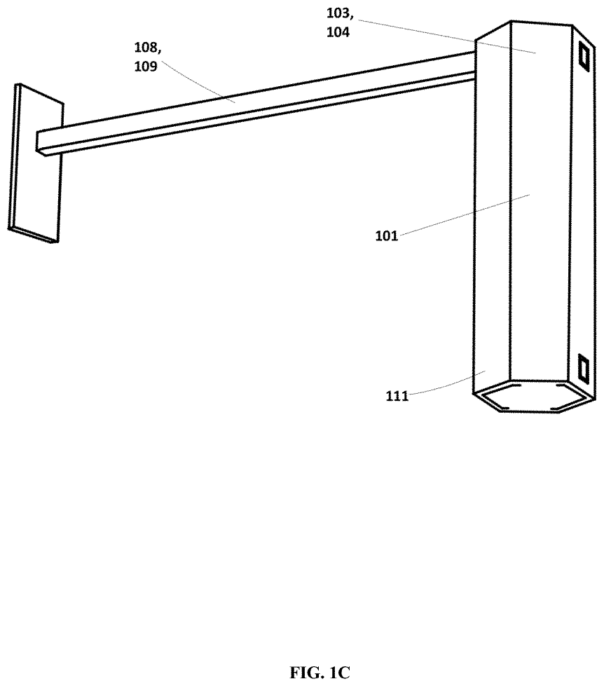

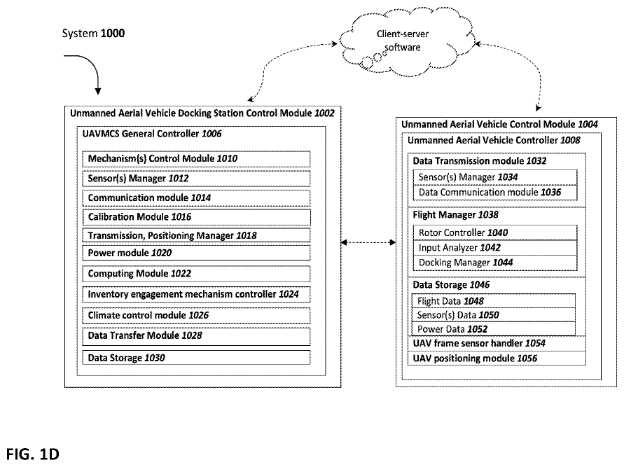

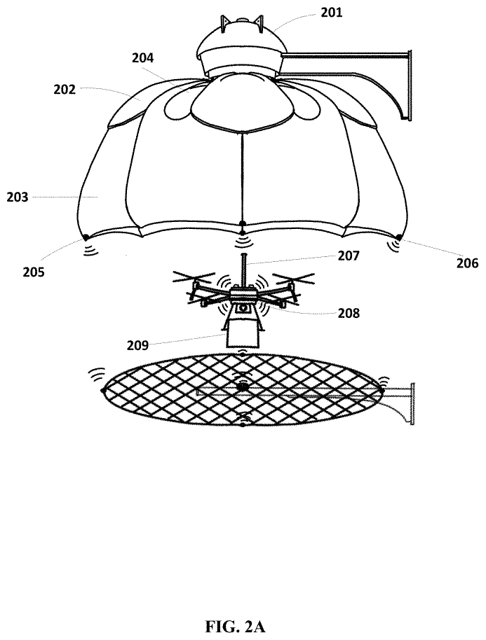

FIG. 1A illustrates a schematic diagram showing an example embodiment of the UAVMCS. As shown in FIG. 1A, the UAVMCS can be mounted as hanging but is not limited to it, so for example, it can be mounted vertically, horizontally, on the top, on the bottom, or on any other side without any limits. As shown in FIG. 1A, the system may include various components for performing the processes and features described herein. For example, as shown in FIG. 1A, the system may include, but is not limited to, a docking housing unit 101, an adapted unmanned aerial vehicle 102 (or simply UAV), a GPS aerial 103, a satellite 104, a helipad 105, which in turn can include one or more sensors 106, and a central positioning sensor 107. Additionally, as shown in FIG. 1A, the UAVMCS may also include, but is not limited to, a top mounting bracket 108, a side bracket 109, and a mounting holder for helipad 110. The design and construction of the docking housing unit, as shown in FIG. 1A, can include an enclosure 112 in close state in a form of parasol or a circular folding frame, but is not limited to this form, which can be covered by water resistant cloth or other hard or soft material and the all-weather protective covers of the docking housing unit, and shape of the parts is not limited to the wide flat ones, which, as shown in FIG. 1A, and in one or more embodiments the enclosure may include one or more all-weather protective covers 111, the number of them may consist of 2-3-4-5-6-7-8-9-10-11-12-13-14-and more parts. Additionally, the UAVMCS can include one or more engagement points within the UAVMCS that secure the adapted UAV 102 in place within the docking housing unit of the UAVMCS. In particular, the UAVMCS can include one or more components that hold, fasten, or otherwise secure the UAV 102 within the docking housing unit. As an example, the UAVMCS can include one or more magnets, grooves, rails, or various soft, inflatable and mechanical components included within the UAVMCS that secure the UAV 102 in place within the UAVMCS. Alternatively, in one or more embodiments, the UAV 102 can include one or more components that secure the UAV 102 within the docking housing unit of the UAVMCS. This can enable the UAV 102 to offload packages safely, for example, and can enable the UAV 102 with the package to be secured during high winds and other adverse weather events.

FIG. 1B illustrates an example of design and construction of enclosure of the UAVMCS, as shown in FIG. 1B, which may include the primary flat wide parts of the enclosure 112 in a closed state 113, but is not limited to this shape, which are made from hard materials: metal, carbon, but is not limited to, and complementary parts of the enclosure 114, which all together with elements of the construction form an all-weather anti-vandal opening and closing states of the enclosure of the UAVMCS.

FIG. 1C illustrates a schematic diagram showing an example embodiment of the docking housing unit of the UAVMCS. As shown in FIG. 1C, the docking housing unit of the UAVMCS can be mounted in a hanging position but is not limited to it, so for example, it can be mounted vertically, horizontally, on the top, on the bottom, or on any other side without any limits. As shown in FIG. 1C, the docking housing unit may include various components for performing the processes and features described herein. For example, as shown in FIG. 1C, the system may include, but is not limited to, a docking housing unit 101 at the form of hexagonal pyramid, cylinder, triangle pyramid, pyramid, but not limited to these shapes, a GPS aerial 103, a satellite 104, which in turn can include one or more sensors, and central positioning sensors. Additionally, as shown in FIG. 1C, the docking housing unit 101 of the UAVMCS may also include, but is not limited to, a top mounting bracket 108 and a side bracket 109. The design and construction of the docking housing unit 101, as shown in FIG. 1C, can include, but is not limited to, a hexagon pyramid or triangle pyramid, but not limited to the shape, which can be comprised of water resistant cloth or other hard or soft material and the all-weather protective covers, and shape of the parts is not limited to the wide flat ones, which, as shown in FIG. 1C. Additionally, the docking housing unit 101 of the UAVMCS can include one or more engagement points within the UAVMCS that secure the UAV 102 in place within the docking housing unit 101 of the UAVMCS. In particular, the UAVMCS can include one or more components that hold, fasten, or otherwise secure the UAV 102 within the docking housing. As an example, the UAVMCS can include one or more magnets, grooves, rails, or various soft, inflatable and mechanical components included within the docking housing unit of the UAVMCS that secure the adapted UAV 102 in place within the UAVMCS; the module equipped with mechanisms for capturing, holding, charging, and refueling the UAV through the upper suspension of docking charging and refueling frame of the UAV. Every example of UAVMCS shown in FIG. 1A-1B-1C, contain an internal tank for refueling, a retractable or static rod, a refueling nozzle, a tube for refueling enclosed in docking housing unit 101 in the case of hexagonal pyramid, or in a case of other form. Moreover, UAVMCS shown on FIG. 1C are capable of forming a charging surface by attaching one to another as indicated in the figure.

FIG. 1D illustrates a schematic diagram showing an example embodiment of an autonomous docking system 1000 (or simply “System 1000”).

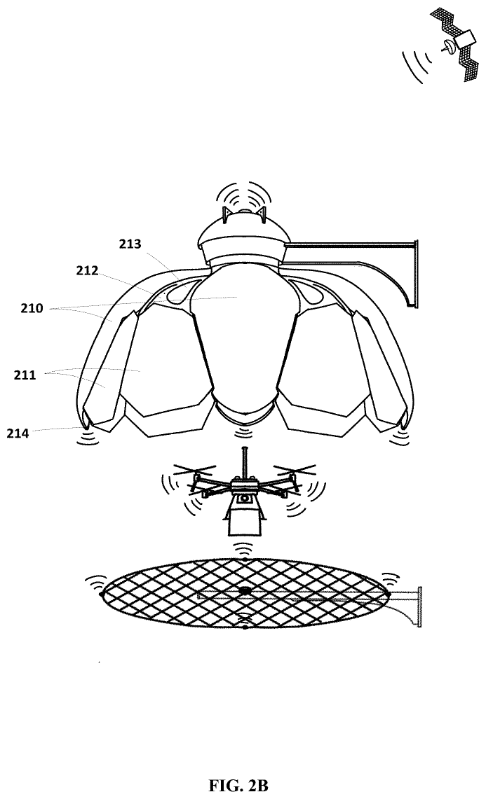

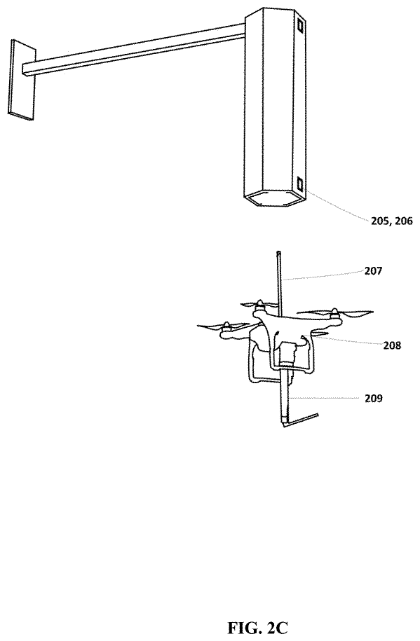

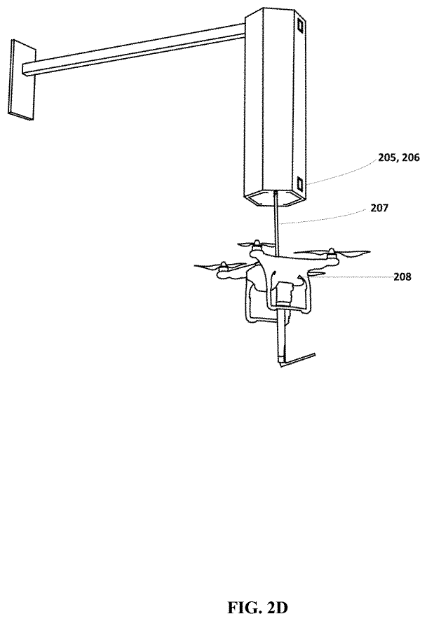

FIG. 2A illustrates the open state of the enclosure of the UAVMCS when a adapted UAV 102 is accurately positioned under the docking housing unit 101. As shown in FIG. 2A, the in one or more embodiment enclosure can include a top cap 201, all-weather protective covers of the enclosure in open state 202, a parasol or a circular folding frame in open state 203, one or more holes for air thrust 204, one or more sensors 205 and 206. As shown in FIG. 2A, the UAV 102 can include a UAV docking charging and refueling frame 207, one or more sensors 208, and a lower suspension mechanism for taking a load 209.

FIG. 2B illustrates a side-perspective view of the open state of the enclosure of the UAVMCS, which, as shown at FIG. 2B, comprising primary flat wide parts of enclosure in open state 210 designed and constructed of hard materials, supplementary parts of the enclosure in an open state 211 designed and constructed of hard materials, fragments from water resistant cloth or soft parts 212 with holes for the air thrust 213, and one or more sensors 214.

Additionally, as illustrated in FIGS. 2A and 2B, in one or more embodiments, the UAVMCS includes a single docking housing unit shaped to receive a single adapted UAV 102 within the UAVMCS. Alternatively, the UAVMCS can include multiple docking housings units having similar or different shapes and sizes.

FIG. 2C illustrates a side-perspective view of the hexagon shaped example of the docking housing unit 101 of the UAVMCS, which, as shown at FIG. 2C, comprises primary flat parts of the docking housing unit designed and constructed of hard, soft or water-resistant cloth materials, and one or more sensors 205, 206. As shown in FIG. 2C, the UAV 102 can include a docking charging and refueling frame of the UAV 207, one or more sensors 208, and a lower suspension mechanism or electro mechanism for taking a cargo 209. FIG. 2C depicts the phase of accurate precise positioning the adapted UAV 102 under the station before docking to the docking housing unit of the station 101. A UAV 102 that performs flights and needs recharging, storing or maintenance, receives preliminary information about the location, geolocation, the nearest available working charging station from the software system described above. When approaching, the adapted UAV 102 identifies a charging station UAVMCS using on-board sensors, but not limited to it—optical, telemetrical, laser, electromagnetic, and other. Before docking, it performs accurate positioning, flying into the docking housing unit of the charging station UAVMCS.

FIG. 2D illustrates the docking phase after precise positioning phase is completed and illustrates the adapted UAV 102 approaching to the receiving assembly of bearing surface of the docking housing unit of the station. After that, the adapted UAV 102 performs a docking process—a flying maneuver which makes the upper suspension, or the docking charging and refueling frame of the UAV 207 caught by the grips of the docking housing unit of the charging station. After that, the UAV 102 is lifted the UAV if required all the way until its body reaches the body of the charger to ensure reliable fixation from swinging.

FIG. 2E illustrates the reliable fixation of the adapted UAV 102 after docking is finished by capturing and lifting if required the UAV 102 using the internal hexagonal docking housing unit 101 lifting systems and electro mechanisms, rotors, until the reliable fixation is reached, as previously described. Also, the lifting and fixing process can be accomplished by lowering the docking housing unit or other cases and devices all the way until they reach the reliable fixation.

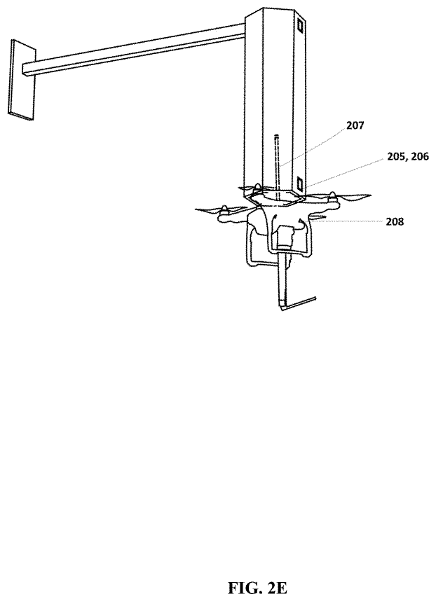

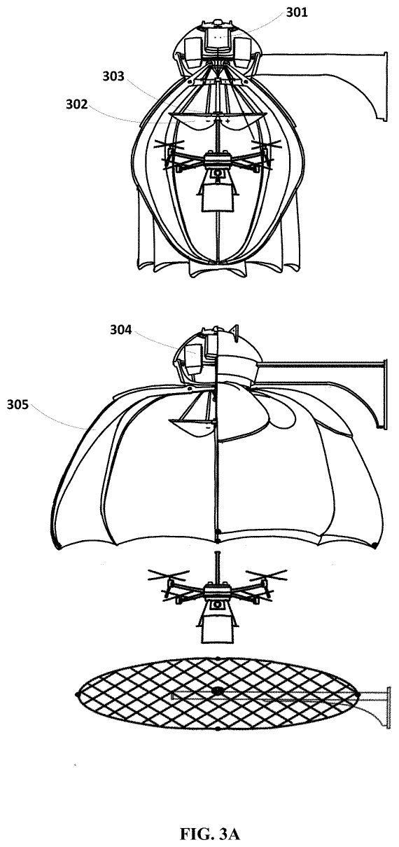

FIG. 3A and FIG. 3B illustrates an example of the open state of the enclosure and docking housing unit 101 of the UAVMCS with a side-lengthwise cutaway drawing and the adapted UAV 102 connected to the UAVMCS for docking in the upper diagram, and an example of the closed state of the enclosure and the docking housing unit 101 of the UAVMCS with a lengthwise cutaway drawing, and the UAV holding in the charge, diagnostics and storage position. As shown in FIG. 3A and FIG. 3B, the adapted UAV 102 is connecting to the docking housing unit 101 of the UAVMCS via the conical bearing surface, but not limited to the conical shape, of the receiving assembly 302 of the docking housing unit 101 until the moment of full electromechanical connection with the receiving assembly of the docking housing unit 101 of the UAVMCS. As shown in FIG. 3A and FIG. 3B, the schematic diagram of control module 304 operates all-weather protective covers of the docking housing and an enclosure in a form of parasol or circular folding frame, but not limited to these form, and changes the state of enclosure of the UAVMCS to open and closed ones.

In one or more embodiments, the UAVMCS includes a bearing surface of the receiving assembly 302 of the docking housing unit 101 having a conical, but not limited to this, shape that receives a UAV 102 within the docking housing unit 101 of the UAVMCS. Additionally, while FIG. 3A and FIG. 3B illustrates one embodiment of the bearing surface of the receiving assembly of the docking housing unit having a conical shape, it is appreciated that the docking housing unit can include other shapes. For example, rather than a conical shape, the docking housing unit can have a pyramid shape or other shape with necessary equipment.

Additionally, the docking housing unit 101 can have a shape that centers around a central axis that extends vertically through the base of the docking housing. For example, as shown in FIG. 3A and FIG. 3B, the docking housing unit can have a conical shape that is centered around a central axis. Further, while not explicitly shown in FIG. 3A and FIG. 3B, the bearing surface of the receiving assembly 302 of the docking housing unit 101 can include any symmetrical shape that is positioned around a central axis. For instance, the bearing surface of the receiving assembly 302 of the docking housing unit 101 can have a cubic pyramid shape (or other symmetrical shape) that centers around a central axis.

As illustrated in FIG. 3A and FIG. 3B, the UAV 102 includes a docking charging and refueling frame 207 coupled to the main body of the UAV 102. In particular, in one or more embodiments, the docking charging and refueling frame 207 is connected to and positioned below the main body of the UAV 102. As shown in FIG. 3A and FIG. 3B, the UAVMCS includes a docking helipad 105, a plurality of charging contacts on the underside of the receiving assembly 302 of the docking housing unit, and a docking charging and refueling frame 207 of the UAV including one or more leg(s).

For example, the UAV docking charging and refueling frame 207 can have a circular, pipe, square, or other symmetrical or non-symmetrical shape positioned around a central axis of the UAV 102. Alternatively, the docking helipad 105 may include a non-symmetrically shaped docking pad positioned around the central axis such as a triangle, rectangle, pentagon, or other shape.

As mentioned above, the UAV docking charging and refueling frame 207 can include any number of legs.

In one or more embodiments, a shape of the UAV docking charging and refueling frame 207 corresponds to a shape of the bearing surface of the receiving assembly 302 of the docking housing unit of the UAVMCS. As such, the UAV docking charging and refueling frame 207 can have a complementary shape to the bearing surface 303 of the receiving assembly 302 of the docking housing unit having a conical, cubic pyramid, or other shape within which the leg(s) of the UAV docking charging and refueling frame 207 and the bearing surface 303 of the receiving assembly 302 of the docking housing unit can fit within when the UAV 102 docks within the docking housing of the UAVMCS. Alternatively, in one or more embodiments, the UAV docking charging and refueling frame 207 can have other shapes corresponding to the shape of the bearing surface 303 of the receiving assembly 302 of the docking housing unit of the UAVMCS.

In addition to providing a structural shape for the adapted UAV 102, the leg(s) of the UAV docking charging and refueling frame 207 can also provide electrical conduits between the UAV charging contacts and one or more electrical components of the UAV 102. For example, in one or more embodiments, the leg(s) electrically couples the UAV charging contacts to a battery assembly on board the UAV 102. Additionally, or alternatively, the leg(s) can electrically couple the UAV charging contacts to one or more of the electrical systems (e.g., motors) that drive the rotors. As such, when an electrical signal (e.g., a power signal) is applied to one or more of the contacts, the leg(s) can route the electrical signal to one or more electrical components of the UAV 102.

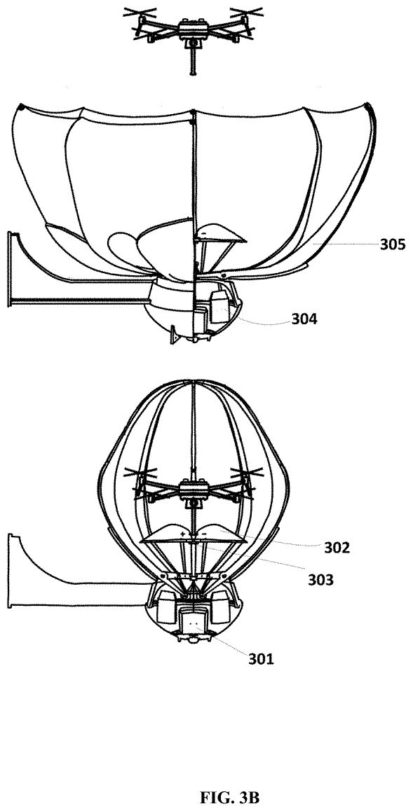

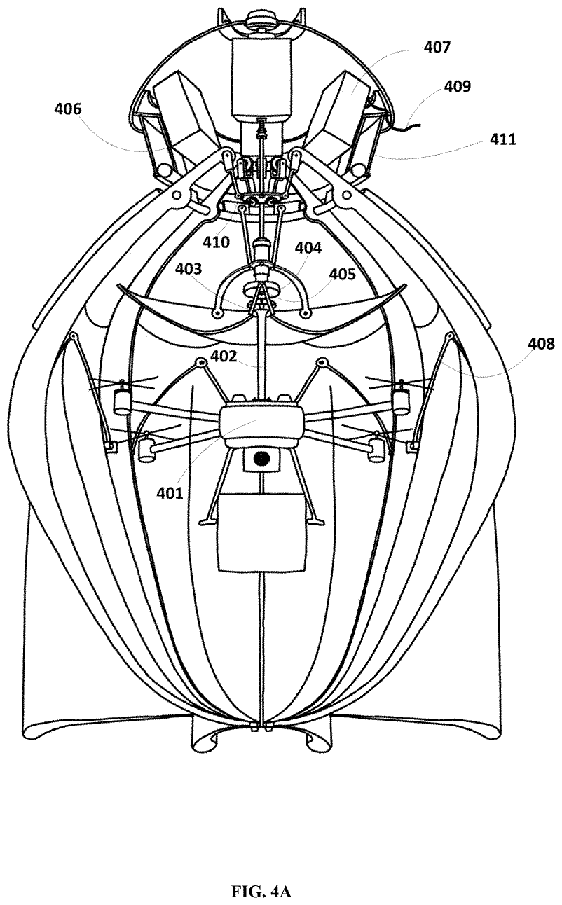

FIG. 4A illustrates a adapted UAV 102/401 connected by the docking charging and refueling frame of the UAV 207/402 to the docking housing unit of the UAVMCS with an enclosure in the close state comprising, but not limited to, locking and charging mechanism 403 for holding, charging, and refueling UAV, a charging port 404 comprising of limit switch with built-in optical sensor, an optical sensor 405, one or more optical sensors 406, an uninterrupted power supply 407, the main metal arm of a parasol or a circular folding frame 408, a power cable 409, an enclosure operation mechanism 410, and protective glass 411. Additionally, a locking and charging mechanism 403 can comprise the electrical systems (e.g., motors) that drive the rotors or pneumoengine or other system, which enables opening and closing states of the locking and charging mechanism 403 and opening and closing states of the enclosure. Additionally the UAVMCS comprising a charging port 404 comprising of limit switch with built-in optical sensor, a control module having a processor and memory, a receiving assembly having at least one sensor mentioned above, control modules 413, bracket motors 414, a GPS unit, a cooling and heating modules, an anchorage or a mounting bracket for attaching.

In some examples, the UAVMCS can also comprise one or more beacons. The beacons can comprise, for example, flashing docking and/or landing on helipad lights, radio beacons, homing beacons, or other indicia to enable UAV 102 to locate the helipad. The beacons can enable the UAV 102 to locate the helipad in adverse weather conditions, for example, or at night. In some examples, the beacons can comprise radio beacons to improve navigation in areas with high light pollution (e.g., in city centers), where landing lights may be difficult to distinguish from surrounding city lights.

FIG. 4B illustrates a UAV in a precise positioning phase for connection by the docking charging and refueling frame 207/402 to the docking housing of the UAVMCS in one of an example of the hexagonal pyramid construction, but not limited to this shape of construction, locking and charging mechanism 403 for holding, charging, and refueling UAV, a charging port 404 comprising of limit switch with built-in optical sensor, a control module having a processor and memory, a receiving assembly having at least one sensor mentioned above, an optical sensor 405, one or more optical sensors 406, an uninterrupted power supply 407, an enclosure operation mechanism 410, control modules 413, bracket motors 414, a GPS unit, a cooling and heating modules, an anchorage or a mounting bracket for attaching. In some examples, the UAVMCS can also comprise one or more beacons. In some examples, the beacons can comprise radio beacons to improve navigation in areas with high light pollution (e.g., in city centers), where landing lights may be difficult to distinguish from surrounding city lights.

FIG. 4B illustrates an example of side view of the embodiment of the docking housing unit of the UAVMCS in form of a hexagonal pyramid (or another form) and comprising a external hexagonal case made from metal (or another hard or soft material), a internal power supply 407. It enables wire and wireless connection; the power supply connection can also be both wired and wireless. It has its own accumulator that can be recharged from different types of power sources. It also has units for connecting a tank or/and a hose for filling and pouring liquid or bulk cargo for the drone. In some examples, the beacons can comprise radio beacons to improve navigation in areas with high light pollution (e.g., in city centers), where landing lights may be difficult to distinguish from surrounding city lights.

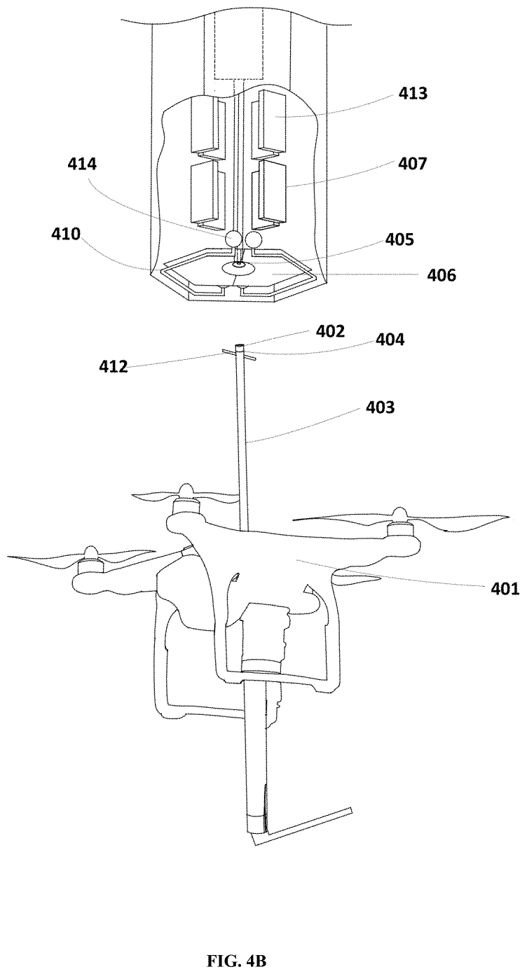

FIG. 5 illustrates an example of side view of the embodiment of the basic station during the process of refueling or refilling the tank for liquid or fuel of the UAV 102. After the docking phase is finished by closing locking and charging mechanism the rod 505, the pipe for filling, pouring fuel or cargo lowers, 502 moves out from the bearing rod of the docking housing unit or remains static to enable engagement with a refueling nozzle of the docking housing unit and UAV refueling mechanism. The reverse situation is also possible when the rod 504 lowers to pump out cargo or fuel from the UAV's tank. After that, the refueling pipe, retractable rod for filling or pouring cargo into the UAV 501 connects with the upper suspension of the UAV, electromagnetic, vacuum or otherwise. After combining these two parts, liquid or bulk cargo or fuel is supplied from the docking housing unit 503 to the UAV or vice versa. After the process of refueling, recharging, pouring is finished, the undocking occurs in the reverse order.

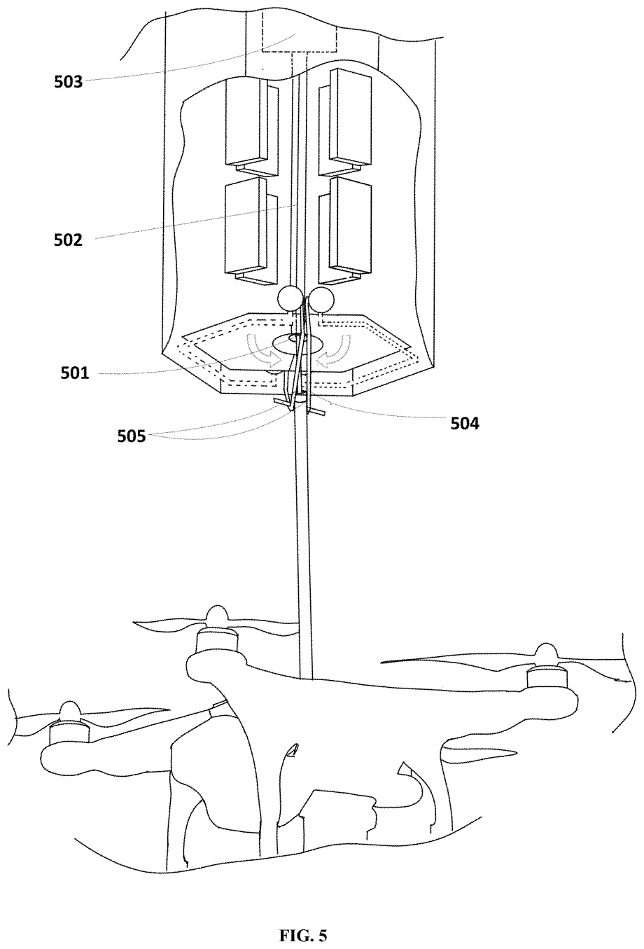

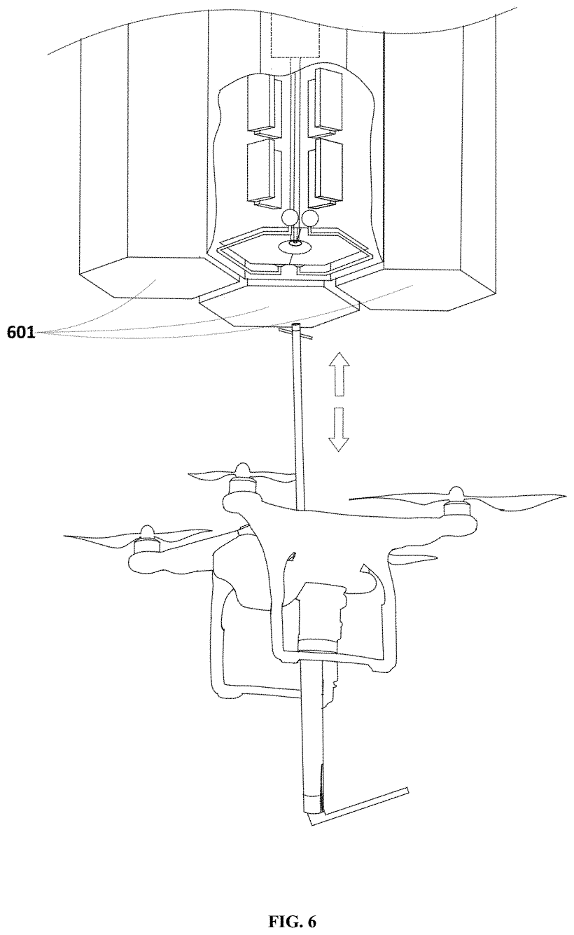

FIG. 6 illustrates an example of side view of the embodiment of the combination of the docking housing units 601 in the form of hexagonal pyramid, but not limited to the form, which are connected with each other by means of magnet, mechanical or electromechanical anchorages making a single flat charging and storing surface. The surface enables taking different types of UAV for recharging, storing, and refilling. It is a compact/inexpensive variant of filling a surface with an exemplary hexagonal docking housing units. The key value of such a combination of docking housing units is reducing the wind load and increasing the docking area enabling allocation of UAVMCS in form of a charging surface on ceilings, under bridges, in hangars—for recharging UAVs on their way to the system. The option enables wireless recharging of UAV when approaching the surface, but not limited to this type of recharging.

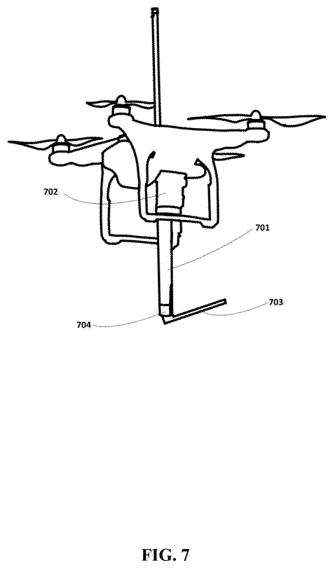

FIG. 7 illustrates an example of side view of the embodiment of the combination of the lower suspension mechanism 701 for autonomous load pickup. The lower suspension mechanism 701 comprising a folding/unfolding mechanism 702 of telescopic form, but not limited to the form, a hook or bracket electro mechanism 703, but not limited to it, made of lightweight, durable, impact-resistant material: metal/carbon/composite. Lower suspension mechanism 701 of the UAV is mde in a form of a pipe, or any other form, with electromechanical automated hook, gripper, or other mechanism for gripping the load. The system of optical sensors 704 that enables UAV to identify an object to deliver, do precise positioning and gripping of the load.

The lower suspension mechanism 701 illustrated in FIG. 7 consists of fastening and fixing elements or folding mechanism 702 connected or engaged to the body of the UAV, the main part, and the load hook/grip mechanism in the form of a hook or bracket, but not limited to it. The folding/unfolding control of the lower suspension mechanism 701 and the hook or bracket electro mechanism 703 is handled by the directing UAV controller. When transfer of load is not needed, or/and when it is necessary to land the UAV on the surface, but not limiting to these cases, the lower suspension mechanism 701 automatically folds into a compact position, which allows the UAV to land freely on its standard legs. The lower suspension folding mechanism 702 for landing of the UAV can be electromechanical, mechanical or implemented in any other way, or using any technology or approach, ensuring smooth landing of the UAV on the surface.

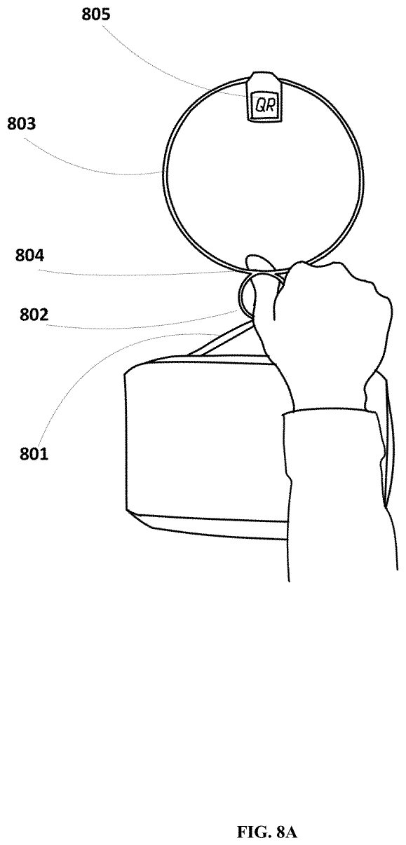

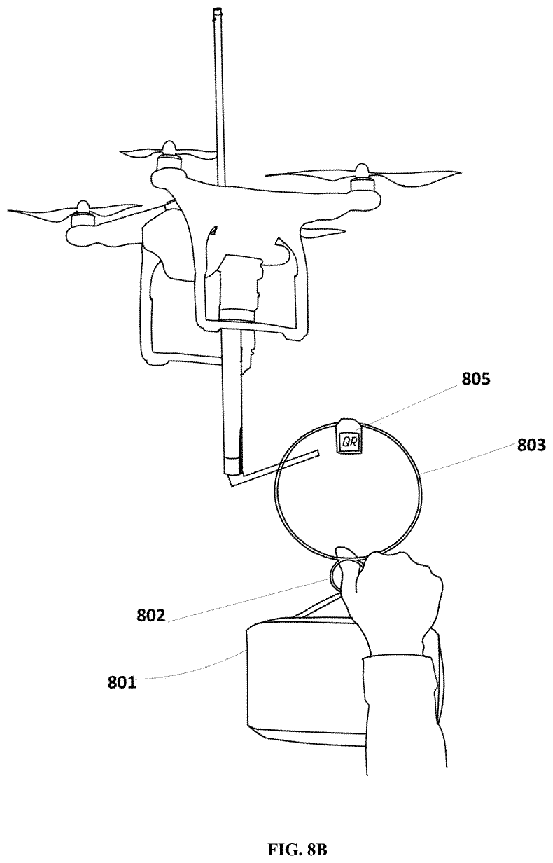

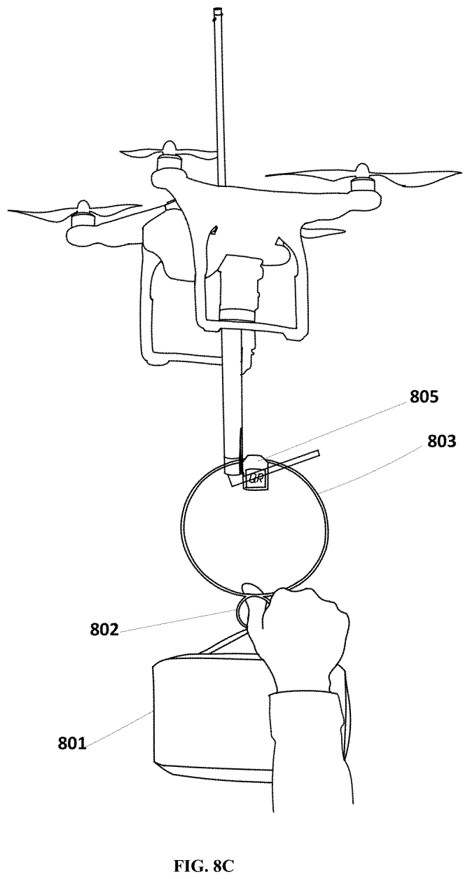

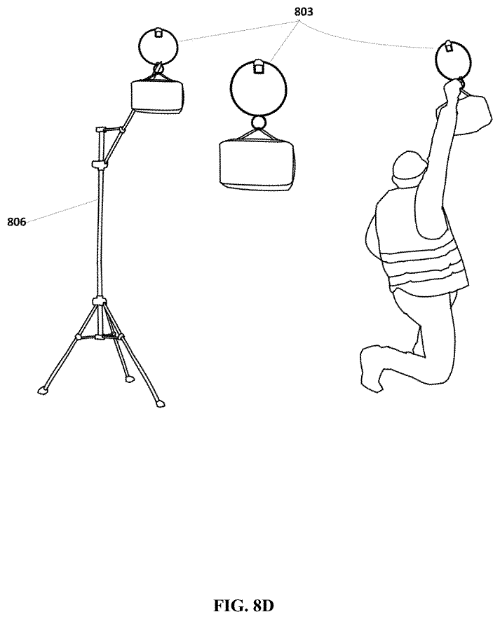

FIG. 8A illustrates an example of the embodiment of the method and system of load positioning member for gripping the package of load located on the outer case. In the example shown in FIG. 8A the sender places the cargo of the corresponding weight in a plastic bag. The sender attaches the top of a plastic bag 801, but not limited to it to the lower, smaller, circle of the loop 802 coupled to a load positioning member 803. After the cargo is attached and securely fastened, a QR code or another ID tag 805 is used by the UAV to precisely aim for the further cargo capture. Next, the sender/the operator lifts the load positioning member 803 and connected cargo on the outstretched arm, as indicated in the FIG. 8A, and sends a signal to the UAV for aiming and capturing the load.

FIG. 8B illustrates an example of the embodiment of the method and system of precise positioning of the UAV for enabling autonomous load picking up. In the shown example, but not limited to this method, the UAV receives geolocation data and, in future, itinerary from the main system. While approaching the target/load pickup point it scans the surrounding environment by means of optical and other sensors 704 for a hanged load. According to the described conditions the UAV performs precise positioning as shown in FIG. 8B, targets the load positioning member 803 (here, the loop) by its lower suspension mechanism 701 or capture device.

FIGS. 8C and 8D illustrate an example of the embodiment of the autonomous method and system of gripping, picking up cargo by the UAV. The FIG. 8C illustrates an example of the embodiment of the moment when the UAV is getting his lower suspension mechanism 703 in the form of gripping hook in this example into the load positioning member 803 with the cargo, which the sender of the cargo is holding in his hand. The loop load positioning member 803 is in the form of ‘8’ or any other form for the cargo fastening. QR code or other ID tag 805 or any other visual, radio, or magnet element that serves aiming of the UAV for capturing the load positioning member 803 with or without the cargo. In the means of cargo that the UAV moves can also be another payload with special grips, equipment, sensors, cameras but not limited to it. The FIG. 8C illustrates an example of the embodiment of the method of holding load positioning member 803 in the form of figure ‘8’ in the state of conditional balance and the loop 802 and the cargo on an outstretched arm for the safe collection of cargo by the UAV directly from the sender's hands.

After completion of the positioning of the UAV in the environment and aiming at the lower suspension mechanism for gripping, picking up cargo, the UAV carries out attack as shown in FIG. 8C, but not limited to the shown method and sequence. The attack is a process of getting a lower suspension mechanism 701 with a hook or bracket electro mechanism 703, but not limited to this type of mechanism, of the lower suspension of the UAV into a load positioning member 803 for gripping, picking up cargo, in this case it is a load positioning member 803 in the shape of an ‘8’, but not limited to this form, size or material. After a successful hit, the UAV continues moving along with the hooked or gripped load in a direction that enables removing the load from the tripod holder for several load positioning members 806 or from the user's hands. At the same time the load positioning member 803 (or other device for removing the load) is captured and/or fixed with a hook or bracket 703 or a lower suspension electro mechanism 701 of the UAV. After finishing fixation and removing the load from the tripod holder of load positioning members 806 or from the user's hands, the UAV continues moving along the route it received from the head system to carry out the delivery of cargo.

FIG. 8D illustrates an example of the embodiment of the autonomous method and system of gripping, picking up cargo by the UAV. A person (including persons with disabilities) is using necessary UAV precautions. A tripod for hanging a load positioning members 806 and a load, or another device that enables securing of the load positioning member 803 and a load 801 in any way. The tripod 806 can be equipped with the necessary accurate positioning sensors or ID tags 805 for the UAV. The tripod 806 can be equipped with special mechanisms, devices for securing load 801 and load positioning members 803 of any form. After securing the package to the lower, smaller, circle of the loop 802 the user can hold the cargo or hang it on a tripod 806 or other device for an accurate pickup of the cargo by the UAV. The UAV can also pick up the cargo directly from the user's hands, an example of the body and hands' position and position of the hands on the load positioning mechanism 803 are shown in the FIG. 8D. A person can take a different body or hands position and secure the cargo in a different way. A person can hold a tripod 806 with a secured load 801. After the cargo and the load positioning mechanism 803 are hung on a device or held by the user, an autonomous capture of the cargo by a UAV is expected. It can be fully autonomous, partly autonomous, automatic, semi-automatic, or manual cargo capture without any limitations.

The following is the process of capturing/collecting of load/bag/box by the UAV using the lower suspension mechanism 701, but is not limited to this algorithm:

1) the UAV receives a control signal with coordinates of the place of loading/location of the system or the person with the package to be sent (including the necessary and sufficient load parameters: weight) and the parameters of the delivery route;

2) the UAV receives a signal with parameters for choosing (identifying) the load using a QR-code 805, but not limited to this type of ID, or other properties;

3) Using optical/navigation/positioning systems of sensors 704 system of optical sensors enabling UAV to identify an object to deliver, do precise positioning and gripping of the load positioning mechanism 803 or sensors of other navigation methods, the UAV performs accurate positioning, approaches the load location;

4) by means of optical sensors, or other sensors 704, but not limited to this method, the target is captured (a special construction of the load positioning mechanism in the form of a ring 803, but not limited to it, which is fixed on the outer case of the package of load 802, on the top/side of it, but not limited to it)

5) then the UAV attacks the load positioning mechanism 803 (the gripping mechanism located on the outer case of the package of load) by calculating and matching parameters of the lower suspension mechanism length 701 and the location of the gripping mechanism comprising a hook or a bracket mechanism 703—a hook or bracket, but not limited to it—it picks up the load positioning mechanism 803 with the load attached to it from the holding mechanism 806 or from the user's hands.

6) at the same time with the capture process, fixation/securing of the load securing mechanism located on the package 802 (ring/loop, but not limited to it) by the lower suspension occurs.

7) the UAV performs a flight by a predefined route of load delivery

8) the UAV flies according to the specified coordinates or other navigation indicators of the location for the cargo unloading

9) by means of sensors and automatic algorithms for detecting obstacles/live organisms/people, the UAV works out conditions for the safe approach to the required altitude for unloading load without landing, and if necessary, gives sound signals acceptable for the environment. In case when no safe route for live organisms/people/objects exists, the UAV acts according to the control algorithm.

10) in case safe unloading is confirmed, the UAV descends to an altitude acceptable for unloading, which depends on the parameters/dimensions of the package/load, but not limited to it, and, while automatically opening the lower suspension mechanism 701 (hook, grab), lowers the load to a position with a predefined accuracy without landing

11) the UAV goes on flying by the predefined route.

The cargo of the UAV is a load limited by the weight that the UAV is capable of carrying to the required distance. The cargo is not limited in size, does not require any special packaging except a pack. The exact place to unload the cargo can be specially equipped with a net for soft cargo reception. The place can be equipped with a special hook so that the drone can hang the cargo on this hook, or the place can be equipped with other mechanisms that allow reliable and safe cargo reception. Also, the place may be not equipped with any devices if cargo is allowed to be dropped off from a height of 2 m. The height to drop off the cargo can be as low as 10 cm.

In one of the examples of the establishing load picking up and unloading process using exact coordinates of the geolocation and performing the necessary recognition of the surrounding environment by means of on-board optical and other sensors 704, the UAV is approaching the cargo unload point appointed by the main system. After choosing the place of cargo unload, the UAV accurately flies in to the equipped/not equipped cargo unload point. Grips or hooks mechanism 703 of the lower suspension mechanism 701 open and release the load that falls on the equipped or not equipped places for cargo reception. In case the unload point is equipped with special devices, such as a tripod 806 for hanging loops and cargo, the drone can hang the cargo using a load positioning member 803 secured to the load.

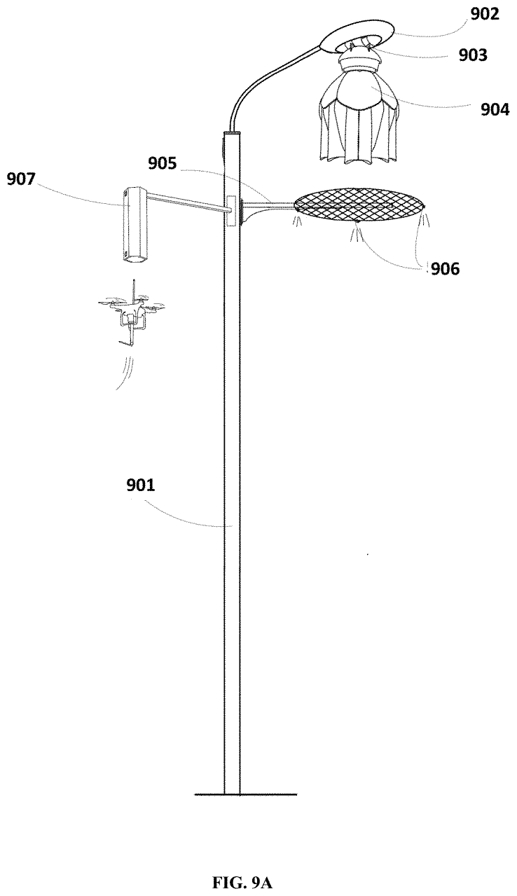

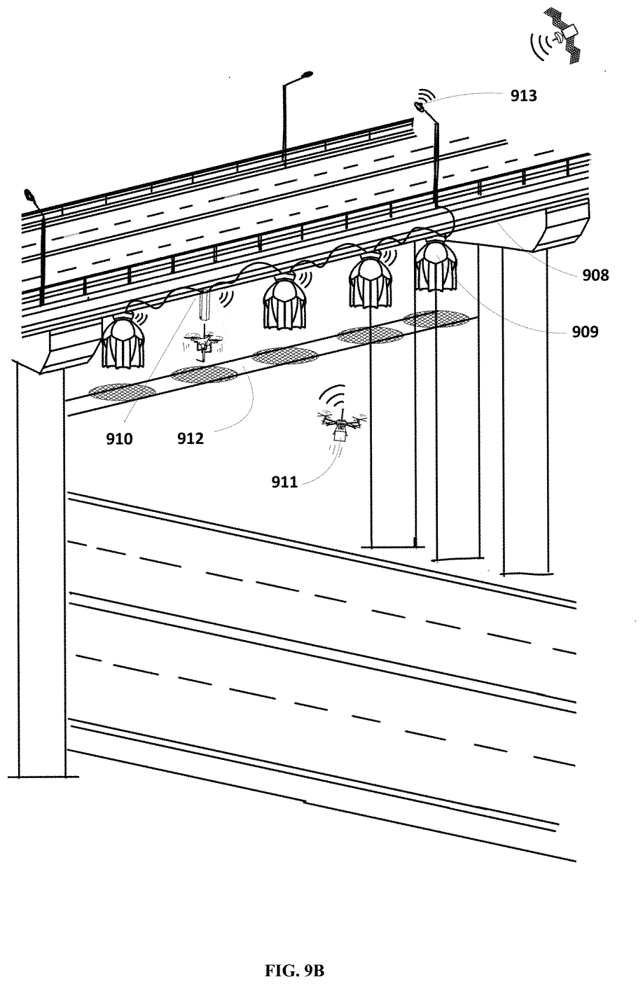

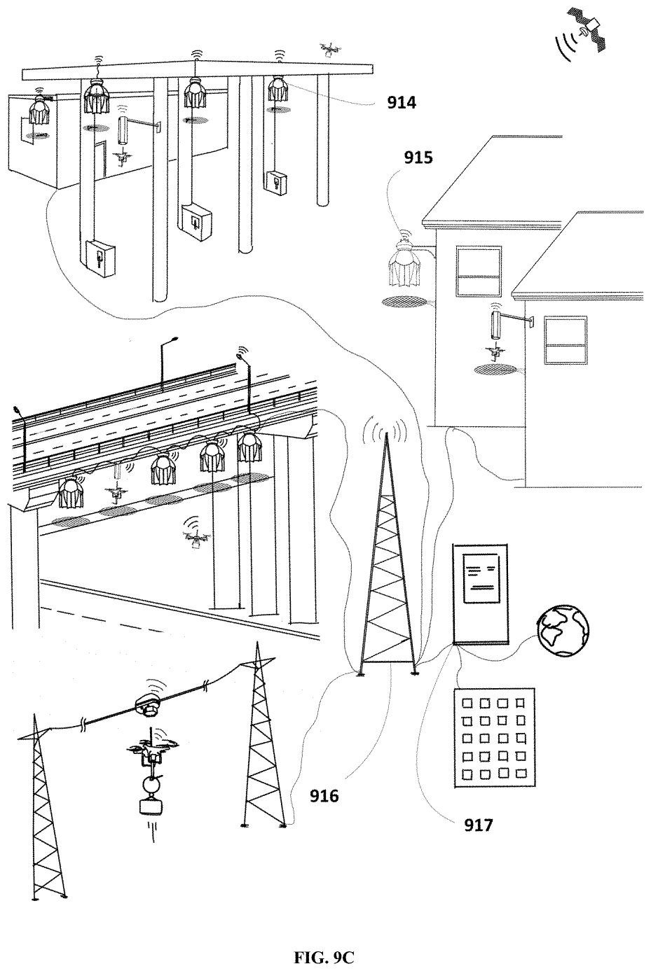

FIG. 9A illustrates an example of side view of the embodiment of a modernized outdoor lighting pole construction performing outdoor lightning function with the UAVMCS mounted on it. As shown in FIG. 9A, the UAVMCS 904, 907 is shown as fixed by the top bracket 903 at the top part 902 on a conventional pole-mounted street light 901 while there may be other embodiments mounted in other ways. As shown in the FIG. 9A, the ensuring helipad surface is fixed below by the side bracket 905 with lights 906 performing protective function, the function of lighting and other functions. As discussed below, however, the UAVMCS could also be installed on other existing structures such as cell towers, church steeples, office buildings, parking decks, radio towers, telephone/electrical poles, and other vertical structures (collectively, “poles”). The UAVMCS can enable the UAVs to, for example, avoid bad weather, recharge/refuel, drop off packages, pick-up packages, communicate with a central control system, reset navigation systems, and await further instructions, among other things. In some examples, the UAVMCS can include a streetlight. In other examples, instead of being mounted on an existing streetlight pole, the service provider may include a new streetlight with the installation. Similarly, the UAVMCS can act as a primary or supplementary (relay) solar energy power station. In some examples the UAVMCS can include solar panels, switches, and other equipment to act as a solar power station. In addition, in some cases, the UAVMCS can also include wireless internet, or “Wi-Fi”, connection. This can not only enable the UAV 102 to communicate with the client-server software central control (i.e., the central facility) and the UAVMCS, but also can provide local free of charge or fee-based Wi-Fi services. This can enable cities to provide free of charge Wi-Fi spots in public parks, buildings, and other public areas without bearing the burden of installing some, or all, of the necessary infrastructure.

In still other examples, the UAVMCS can include video cameras. These can be used by local authorities for traffic monitoring and crime prevention, among other things. In some configurations, the UAVMCS can also include weather stations. The weather stations can provide wind speed and direction, temperature, and other weather related to both the UAV 102, the client-server software central control, and to the local residents, businesses, and government entities. In this manner, the UAVs and client-server central control can create efficient routes for the UAVs to avoid, for example, excessive winds, head winds (which can negatively affect flight range), and severe weather. Similarly, a networked series of UAVMCS can provide highly granular weather reporting without the need for separate infrastructure.

FIG. 9B illustrates an example of a side-perspective view of the UAVMCS 909, 910 mounted under a bridge 908. As shown in FIG. 9B, GPS aerial 913 of one or more the UAVMCS can be fixed on the top part of a bridge 908, including but not limited to, a light pole, for better signal transmittance and reception. As further shown in FIG. 9B, ensuring helipads 912 can be mounted under one or more the UAVMCS to ensure safety for UAVs 911.

FIG. 9C illustrates examples of side-perspective views of schematic diagrams of the UAVMCS mounted, including, but not limited to, on gas stations 914, buildings 915, pylons 917, bridges, power lines 916 and other constructions. FIG. 9C illustrates examples of schematic diagrams of the compact application of the UAVMCS for charging, storage, recharging and refueling with cargo on board without landing. It is mounted directly on the wires of power lines. It converts the energy of the wires into energy necessary for recharging the UAV, refueling from the internal contact tank of the device, but not limited to this actions.

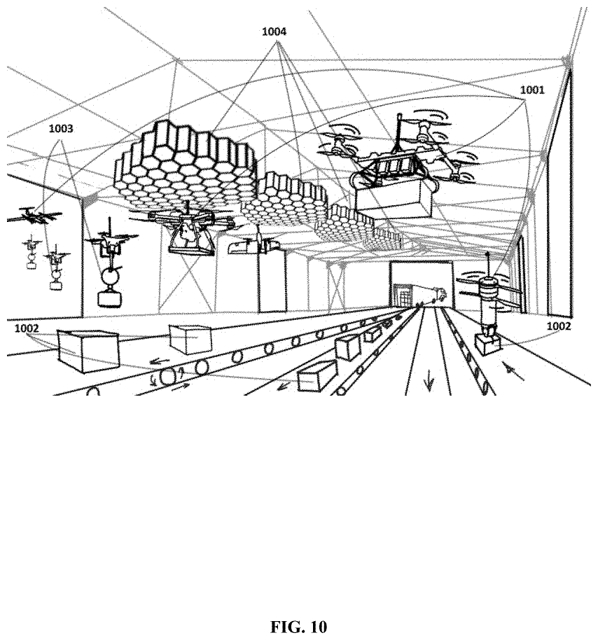

FIG. 10 illustrates an example of side-perspective views of schematic diagrams of the UAVMCSs which can be used to organize an autonomous logistic center for the distribution and delivery of goods using drones. Various vertical take-off and landing drone types 1001, equipped with the upper and lower suspensions mechanisms 1003 and controlled by the software system described above, carry out the cargo pickup 1002, cargo delivery, recharging, refueling, completely autonomously without human intervention. The FIG. 10 shows the interaction of delivery trucks, cargo unloading conveyors and a swarm of UAVs, as an example, but not limited to the shown one.

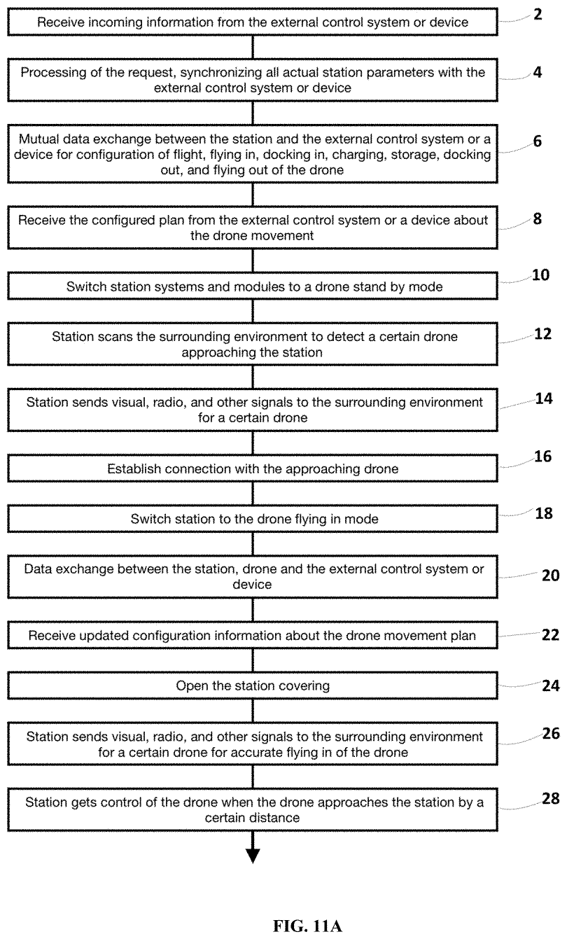

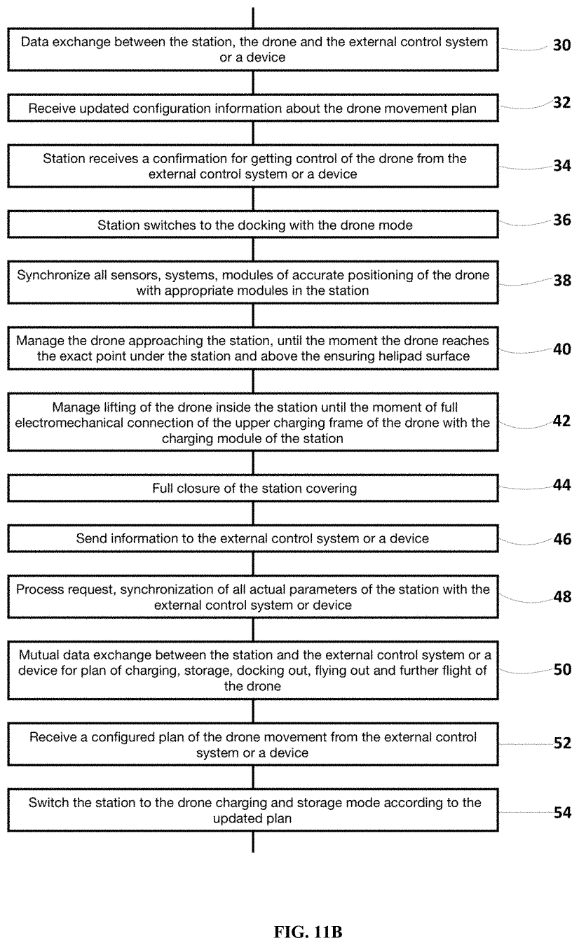

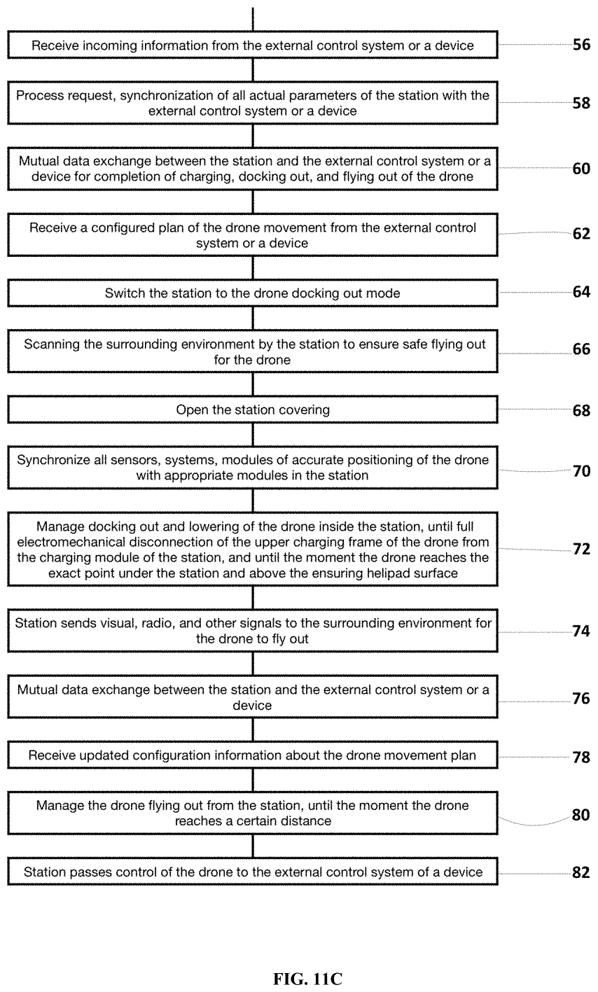

FIG. 11A, 11B, 11C illustrate a simplified flowchart of a series of acts in method of autonomously docking a UAV in accordance with one or more embodiments.

Additionally, as mentioned above, FIG. 1D illustrates a schematic diagram showing an example embodiment of an autonomous docking system 1000 (or simply “system 1000”). As shown in FIG. 1D, the system 1000 may include various components for performing the processes and features described herein. For example, as shown in FIG. 1D, the system 1000 may include, but is not limited to, an Unmanned Aerial Vehicle Docking Station Control Module 1002, Unmanned Aerial Vehicle Control Module 1004, and client-server software. As shown in FIG. 1D, the UAVMCS Control Module 1002 can include a UAVMCS general controller 1006, which in turn can include, but is not limited to, a mechanism(s) control module 1010, sensor(s) manager 1012, communication module 1014, calibration module 1016, transmission, positioning manager 1018, power module 1020, computing module 1022, inventory engagement mechanism controller 1024, climate control module 1026, data transfer module 1028, and data storage 1030 including docking data and UAV data. As shown in FIG. 1D, the UAV control module 1004 can include a UAV controller 1008, which in turn can include, but is not limited to, a data transmission module 1032 including sensor(s) manager 1034 and data communication module 1036, a flight manager 1038, a data storage 1046, UAV frame sensor handler 1054, and UAV positioning module 1056. As shown in FIG. 1D, the flight manager 1038 can include a rotor controller 1040, input analyzer 1042, and docking manager 1044. As FIG. 1D further shows, the data storage 1046 can further include flight data 1048, sensor(s) data 1050, and power data 1052.

Each of the components 1006-1030 of the UAVMCS general controller 1006, and the components 1032-1056 of the UAV controller 1008 can be implemented using a computing device including at least one processor executing instructions that cause the system 1000 to perform the processes described herein. In some embodiments, the components 1006-1030 and 1032-1056 can comprise hardware, such as a special-purpose processing device to perform certain functions. Additionally, or alternatively, the components 1006-1030 and 1032-1056 can comprise a combination of computer-executable instructions and hardware. For instance, in one or more embodiments the UAV 102 and/or the UAVMCS include one or more computing devices. In one or more embodiments, the UAVMCS general controller 1006 and the UAV controller 1008 can be custom applications installed on the UAVMCS and the UAV 102, respectively. In some embodiments, the UAVMCS general controller 1006 and the UAV controller 1008 can be remotely accessible over a wireless network.

Additionally, while FIG. 1D illustrates a the UAVMCS general controller 1006 having components 1006-1030 located thereon, it is appreciated that the UAV controller 1008 can include similar components having features and functionality described herein with regard to the UAVMCS general controller 1006. Similarly, while FIG. 1D illustrates a UAV controller 1008 having components 1032-1056 located thereon, it is appreciated that the UAVMCS general controller 1006 can include similar components having features and functionality described herein with regard to the UAV controller 1008. As such, one or more features described herein with regard to the UAVMCS general controller 1006 or the UAV controller 1008 can similarly apply to both the UAVMCS general controller 1006 and/or the UAV controller 1008.

As described above, the system 1000 includes components across both the UAVMCS and the UAV 102 that enable the UAV 102 to autonomously dock in the UAVMCS. Accordingly, the system 1000 includes various components that autonomously guide the UAV 102 to dock with the UAVMCS without any external intervention (e.g., without an operator remotely controlling the UAV during the docking process). As mentioned above, the guidance system can include the use of transmitters on the UAVMCS that each transmits one or more different types of energy. Also as mentioned above, the guidance system can include the use of sensors on the UAV 102 that each detects one or more of types of energy that the UAVMCS transmits. By utilizing the transmitters on the UAVMCS to transmit energy, and the sensors on the UAV 102 to detect the energy, the system 1000 can autonomously guide and dock the UAV 102 into the UAVMCS.

Accordingly, as mentioned above and as illustrated in FIG. 1D, the UAVMCS general controller 1006 includes a transmission, positioning manager 1018. In one or more embodiments, the transmission manager 110 controls the transmissions of all applicable types of energy from the UAVMCS for the purpose of guiding a UAV 102 for autonomous docking at the UAVMCS. For example, the transmission, positioning manager 1018 can control transmissions of energy from the UAVMCS including light energy, electromagnetic energy, radio frequency energy, infrared energy, and other types of detectable energy.

For example, the transmission, positioning manager 1018 can control or otherwise manage a transmission of a particular pattern of energy and/or energy type to guide the UAV 102 within a threshold distance of the UAVMCS. For instance, in one or more embodiments, the UAV 102 can transmit an energy wave to facilitate short-range guidance of the UAV 102 to within a vertical space positioned under a docking housing of the UAVMCS. As such, the transmission, positioning manager 1012 can control a transmission of an energy field that brings a UAV 102 within a docking space of the UAVMCS.

In addition to the transmission, positioning manager 1018, the UAVMCS general controller 1006 also includes a sensor(s) manager 1012 that can sense various conditions surrounding a the UAVMCS and/or UAV 102. In one or more embodiments, the transmission, positioning manager 1018 may control the transmission of different types of energy and/or data based on conditions surrounding the UAVMCS. For example, on a foggy day, the transmission, positioning manager 1018 may determine to transmit a type of energy wave other than a light energy wave because the light energy wave would be hard for the UAV 102 to perceive through the fog. Accordingly, in order to identify conditions surrounding the UAVMCS, the sensor manager 1012 can sense various conditions including weather conditions (e.g., rain, fog), barometric pressure, wind, light, and so forth.

Additionally, as shown in FIG. 1D, the UAVMCS general controller 1006 includes a power module 1020. In one or more embodiments, the power module 1020 controls a charging interface for charging one or more batteries on board the UAV 102. For example, when a UAV 102 docks within a docking housing of the UAVMCS and forms an electrical connection between charging contacts on the UAV and the UAVMCS charging contacts, the power module 1020 can detect the electrical connection between the various contacts and cause the UAVMCS to charge the battery of the UAV 102. In one or more embodiments, power module 1020 charges the UAV 102 in response to detecting that the UAV 102 has docked within the UAVMCS and established an electrical connection between charging contacts on the UAV and corresponding UAV charging contacts. Alternatively, the power manager 1020 can charge the UAV 102 in response to receiving a user input or confirmation to charge a power source of the UAV 102.

As mentioned above, and as illustrated in FIG. 1D, the UAVMCS general controller 1006 which in one or more embodiments can handle general system tasks including, for example, data storage, UAV docking, receiving and processing user input, etc. As an example, after the UAV 102 autonomously docks with the UAVMCS, the UAVMCS general controller 1006 can manage receiving and processing user input with regards to recharging a battery or refueling a tank while the UAV 102 is docked. As another example, in one or more embodiments, the UAVMCS general controller 1006 can manage downloading or transferring data collected by the UAV 102 (e.g., during a previous flight).

Furthermore, as mentioned above, and as illustrated in FIG. 1D, the UAVMCS general controller 1006 also includes a data storage 1030, which can include, but is not limited to, docking data, and UAV data. In one or more embodiments, the docking data can include data representative of docking information associated with the UAV 102. Similarly, in one or more embodiments, the UAV data can include data representative of information associated with the UAV 102.

As described above, the system 1000 enables the UAV 102 to dock autonomously with the UAVMCS. Accordingly, in one or more embodiments, the UAV 102 includes a UAV controller 1008 that detects and uses the energy provided by the UAVMCS to autonomously dock the UAV 102 with the UAVMCS. For example, in one or more embodiments, the UAV controller 1008 detects the energy the UAVMCS transmits, and then uses the detected energy to determine how to guide the UAV 102 (e.g., based on one or more characteristics of the detected energy, the UAV controller 1008 can cause the UAV 102 to perform one or more maneuvers).

As shown in FIG. 1D, the UAV controller 1008 includes a UAV frame sensor handler 1054 that manages and generates input based on one or more signals detected by the UAV 102 and/or based on one or more signals provided to the UAV 102 by the UAVMCS. Additionally, the UAV frame sensor handler 1054 can manage one or more cameras and/or a variety of energy sensors (e.g., electromagnetic energy wave sensors, infrared energy wave sensors, radio frequency wave sensors, image, laser, ultrasound, optical sensors, etc.). In particular, the UAV frame sensor handler 1054 can control directions, angles, filters, sensor activation, sensor sensitivity, and other features and functionality provided by the various sensors on board the UAV controller 1008.

Further, as shown in FIG. 1D, the UAV controller 1008 also includes a flight manager 1038. In one or more embodiments, and in order for the UAV 102 to autonomously dock with the UAVMCS, the flight manager 1038 can control all of the mechanical flight elements associated with the UAV 102 (e.g., motors, rotor arms, rotors, landing gear, etc.). For example, in at least one embodiment, the flight manager 1038 can receive inputs from the UAV frame sensor handler 1054. The flight manager 1038 can then control various mechanical features of the UAV 102 based on the received inputs from the UAV frame sensor handler 1054 in order to autonomously dock the UAV 102 on the UAVMCS.

As illustrated in FIG. 1D, the flight manager 1038 includes a rotor controller 1040. In one or more embodiments, the rotor controller 1040 controls the speed of one or more rotors associated with the UAV 102. Accordingly, by controlling the speed of the rotors, the rotor controller 1040 can cause the UAV 102 to travel up and down vertically. Additionally, in one or more embodiments, the rotor controller 1040 controls the pitch of the UAV 102 by controlling the relative speeds of the rotors. Accordingly, by controlling the pitch of the UAV 102, the rotor controller 1040 can cause the UAV 102 to travel back and forth, and side to side horizontally. Thus, it follows that, by controlling the speed and pitch of one or more rotors associated with the UAV 102, the rotor controller 1040 can cause the UAV 102 to travel anywhere within an uninhibited three-dimensional space.

Also as illustrated in FIG. 1D, the flight manager 1038 includes an input analyzer 1042. In one or more embodiments, the input analyzer 1042 analyzes the data or inputs received from the UAV frame sensor handler 1054 in order to determine a position of the UAV 102. For example, in one embodiment, the input analyzer 1042 can analyze digital images or video provided by a camera on the UAV 102 to determine whether the UAV 102 is located in a position below the UAVMCS. In another example, the input analyzer 1042 can analyze energy sensor readings of an energy wave to determine how far below the UAVMCS the UAV is located 102 (e.g., the altitude of the UAV). The input analyzer 1042 can utilize algorithms, lookup tables, etc. in order to determine the UAV's 102 position based on inputs received from the UAV frame sensor handler 1054. Additionally, in at least embodiment, the input analyzer 1042 can receive inputs from a global position system associated with the UAV 102 in order to determine the UAV's 102 position.

As mentioned above, the flight manager 1038 can further include a docking manager 1044. Once the input analyzer 1042 determines the position of the UAV 102, the docking manager 1044 can determine how the UAV's 102 position needs to change in order to complete an autonomous docking sequence. In one or more embodiments, the docking manager 1044 includes various flight sequences that include decision trees to determine how to move the UAV 102 from one docking phase to the next. For example, docking phases in an autonomous docking sequence can include: a centering phase, wherein the docking manager 1044 centers the UAV 102 under the UAVMCS with complementary support by sensor(s) manager mounted on helipad positioning surface; an ascent phase, wherein the docking manager 1044 causes the UAV 102 to move toward the UAVMCS in a controlled ascent; a correction phase, wherein the docking manager 1044 corrects the position of the UAV 102 due to a gust of wind or debris interference; and a docking phase, wherein the docking manager 1044 causes the flight components of the UAV 102 to shut off, effectively docking the UAV 102 with the UAVMCS. Accordingly, the input analyzer 1042 can comprise various sets of instructions or decisions trees that correspond to each of the phases of a docking sequence.

As an example, the UAV frame sensor handler 1054 can detect that the UAV 102 is within a threshold distance or touching a docking housing of the UAVMCS. The UAV frame sensor handler 1054 can provide an input to the input analyzer 1042, which analyzes the sensor input and determines that the UAV 102 is within a docking distance from the UAVMCS. Accordingly, the docking manager 1044 can cause the rotor controller 1040 to cut some or all power to the rotors associated with the UAV 102. With no power to the rotors, and with the UAV 102 within an effective docking distance from the UAVMCS, the UAV 102 can dock within the docking housing of the UAVMCS. Additionally, as it will be described in greater detail below, the UAVMCS and the UAV 102 may include additional features that enable the UAV 102 to self-align within the docking housing of the UAVMCS as the UAV 102 is docking and/or when the rotor controller 1040 cuts power to the rotors to enable the UAV 102 to dock.

Furthermore, as mentioned above, and as illustrated in FIG. 1C, the UAV controller 1008 also includes a data storage 1046. As shown, the data storage 1046 can include flight data 1048 and sensor data 1050. In one or more embodiments, the flight data 1048 can include data representative of the UAV's 102 flight, such as described herein (e.g., GPS information, camera information, etc.). Similarly, in one or more embodiments, the sensor data 1050 can include data representative of information gathered by one or more sensors located on the UAV 102. Additionally, in one or more embodiments, the data storage 1046 can include power data 1052. The power data 1052 can include data representative of power information associated with a battery and/or one or more power systems on board the UAV 102. For example, the power data 1052 can include a battery level, a remaining life of a battery, or a time for the battery on board the UAV 102 to recharge when docked within the UAVMCS.

As mentioned above, the UAV 102 includes a battery. In one or more embodiments, the battery provides power functionality to the UAV 102. For example, the battery can include one or more power contacts that couple to various components of the UAV 102 and provide battery power throughout the UAV 102. For instance, the battery can provide a power signal to the rotors and power flight of the UAV 102. Further, the battery can provide power to a camera, a processor, and other electrical components on the UAV 102.

Additionally, in one or more embodiments, the battery can provide data functionality to the UAV 102. For example, in addition to the power contact(s), the battery can include one or more data contacts that couple to an SD card, hard drive, or other storage component on the UAV 102 and/or on the battery itself. As such, the battery can provide both power and data functionality to the UAV 102.

Each of the power and/or data contacts can couple to one or more UAV charging contacts. As such, a power signal can be routed between the UAV charging contacts and power contacts on the battery. Additionally, a data signal or communication signal can be routed between the UAV charging contacts and a data contact on the battery. In one or more embodiments, power contacts and data contacts on the battery correspond to different UAV charging contacts. For example, a first group of the charging contacts can couple to one or more power contacts of the battery while a second group of the charging contacts can couple to one or more data contacts on the battery. Additionally, when the UAV 102 is docked within the UAVMCS and the UAV charging contacts electrically couple to corresponding the UAVMCS charging contacts, the UAVMCS and/or UAV 102 can charge the battery using a power signal as well as communicate data using a data signal.

As mentioned above, the UAV 102 can dock within the UAVMCS. In particular, when docking, the docking base and/or UAV docking charging and refueling frame 207 can make contact with a portion of the docking housing of the UAVMCS and cause the UAV 102 to self-align within the UAVMCS. As an example, FIGS. 3-4 illustrate a UAV 102 docking within the UAVMCS in accordance with one or more embodiments.

In particular, FIG. 1A illustrates the UAV 102 approaching the UAVMCS with the leg(s) of the UAV docking charging and refueling frame 207 in front, connecting to the bearing surface of the receiving assembly of the docking housing 302, and making contact with the docking housing of the UAVMCS. In particular, FIG. 1A shows the UAV 102 approaching the UAVMCS from above the UAVMCS. In particular, as described above, the flight manager 1038 of the UAV 102 can cause the UAV 102 to fly within a space below the opening of the docking housing. The flight manager 1038 can then cause the UAV 102 to ascend within the docking housing.

Notwithstanding inexact alignment and tilt of the UAV 102 as the UAV 102 approaches the UAVMCS, the shape of the docking housing as well as the shape of the UAV 102 can compensate for inexact alignment and tilt between the UAV 102 and the UAVMCS. The imprecise alignment and tilt of the UAV 102 can be caused by a variety of factors including, but not limited to, inexact measurement of sensors, environmental factors (e.g., wind), operational error, and other contributing factors that affect the position and angle of the UAV 102 relative to the UAVMCS prior to successfully docking within the UAVMCS. For example, as shown in FIGS. 2A-2B, the special design of the docking housing, which is designed to meet the specifics of the turbulence and the tunnel thrust, allows the UAV 102 to align and precisely follow the docking instruction of the flight manager 1038. Thus, after positioning relative to the safety helipad 105 when the flight manager's docking instructions are executed, the UAV 102 can self-align in the docking housing when the UAV 102 continues to rise to reach the receiving assembly of the docking housing 303. In one or more embodiments, the shape of the bearing surface of the receiving assembly of the docking housing 302, or the shape of the UAV docking charging and refueling frame 207, may allow the UAV 102 to self-align until the docking charging and refueling frame reaches the opening of the orifice of the receiving assembly of the docking housing. Additionally, as shown in FIG. 2A-2B, under the control of the flight manager 1038 and computing module 1022 in synchronization with the sensor manager 1012, the transmission, positioning manager 1018, calibration module 1016, the UAV 102 can self-correct until it comes into contact with the charging port 404 comprising of limit switch with built-in optical sensor of bearing surface of the receiving assembly of the of the UAVMCS. In one or more embodiments, the UAV 102 gradually adjusts till the UAV 102 moves upward towards the UAVMCS receiving assembly.

As mentioned above, the UAV docking charging and refueling frame 207 can include a plurality of UAV charging contacts that electrically couple to the UAVMCS charging contacts of the docking housing. When the UAV 102 docks within the UAVMCS, the UAVMCS charging contacts can electrically couple to the UAV charging contacts and provide various functionalities to the autonomous docking system 1000. For example, when the UAVMCS charging contacts are coupled to the UAV charging contacts, the UAVMCS and the UAV 102 can communicate data, provide a power signal to the UAV 102, provide auxiliary power to the UAV 102, and/or charge a battery on board the UAV 102.

Additionally, the UAV charging contacts include one or more tabs. In one or more embodiments, the tabs can include electrically conductive metal surfaces that come into contact with and establish correspondingly the UAVMCS charging contact on the UAVMCS. Additionally, the tabs can provide a spring between the UAV 102 and the UAVMCS that facilitates a more reliable connection between the UAV charging contacts and corresponding the UAVMCS charging contacts. Additionally, the UAV charging contacts include securing points between each of the UAV charging contacts and the docking receiving assembly. For example, each of the UAV charging contacts may include two or more securing points that fasten the UAV charging contacts in place relative to charging port 404 comprising of the limit switch with built-in optical sensor of the receiving assembly of the docking housing.

In one or more embodiments, each of the UAV charging contacts are electrically coupled to a battery system within the main housing of the UAV 102. For example, one or more of the UAV charging contacts may be coupled to a respective node of a battery system. In one or more embodiments, each UAV charging contact is coupled to a different electrical node within the UAV 102. As an example, a first UAV charging contact can couple to a positive node of a battery while a second UAV charging contact couples to a negative node of the battery. Further, a third UAV charging contact and fourth UAV charging contact can couple to a different component within the UAV 102 (e.g., motors, circuit board, etc.). As an alternative, one or more UAV charging contacts can couple to a first node within the UAV 102 while one or more UAV charging contacts can couple to a second node within the UAV 102. For example, in one or more embodiments, the first UAV charging contact and the second UAV charging contact electrically couple to a positive node of the battery while the third UAV charging contact and the fourth UAV charging contact electrically couple to a negative node of the battery. Additionally, the UAV docking charging and refueling frame 207 can have a variety of shapes and arrangements of UAV charging contacts on an underside of a docking housing receiving assembly.

As shown in FIG. 1A, the UAVMCS may be fixed on one or more external holders, including but not limited to, by means of a top mounting bracket 108 or a side mounting bracket 109. As it is also shown in FIG. 1A, the UAVMCS receives GPS coordinates from the satellite 104 via the GPS aerial 103.

In still other examples, the UAVMCS can comprise one or more GPS receivers 103. In some examples, the UAVMCS can send GPS coordinates to the UAV 102 when it is positioned on the helipad to enable the UAV 102 to calibrate or “zero-out” its navigational system. In other words, the location of the UAVMCS can be measured very accurately using a relatively sophisticated GPS receiver, land surveying equipment, or other means. The UAVMCS can then provide this corrected GPS location to the UAV 102, which may have relatively simpler GPS system with some inherent error. This can provide a correction factor to the UAV 102 to increase the accuracy of the onboard GPS system.

In other examples, the UAVMCS can comprise the same type of GPS receiver as that used on the UAV 102. In that manner, the UAVMCS, which is stationary, can compare the GPS location provided by the GPS receiver to the known GPS location, calculate a correction factor, and provide the correction factor to the onboard GPS receiver on the UAV 102.

As shown in FIG. 1A, the UAVMCS may receive incoming information from external control system or device, it then processes the request, synchronizing all actual station parameters with the external control system or device. As shown in FIG. 1A, the UAVMCS further may perform mutual data exchange with the external control system or a device for configuration of flight, flying in, docking, charging, storage, and flying out of the UAV 102. As shown in FIG. 1A, the UAVMCS may receive the configured plan from the external control system or a device about the UAV 102 movement. As shown in FIG. 1A, the UAVMCS further may switch the systems and modules to a UAV 102 “stand by” mode. As shown in FIG. 1A, the station further may scan the surrounding environment to detect a certain UAV 102 approaching the UAVMCS. As shown in FIG. a 1A, the UAVMCS further may send visual, radio, and other signals to the surrounding environment to establish connection with the approaching UAV 102. As shown in FIG. 1A the UAVMCS may use sensors 105 and 106 to exchange data with a UAV 102. As shown in FIG. 1A, the UAVMCS further may switch to the UAV flying in mode. As shown in FIG. 1A, the system 100 further may exchange data between the UAVMCS, UAV 102 and the external control system or device. As shown in FIG. 1A, the UAVMCS may further receive updated configuration information about the UAV 102 movement plan. After that the docking housing 203 may open as shown in FIG. 2A. As shown in FIG. 2A, the UAVMCS also includes a top cap 201, a guiding arm, all-weather protective covers of the docking housing 202, a parasol or a circular folding frame 203, one or more holes for air thrust 204, one or more sensors 205 and 206. As shown in FIG. 2A, the UAVMCS may open the docking housing and may send visual, radio, and other signals to the surrounding environment using for a certain UAV 102 for accurate flying in of the UAVMCS. As shown in FIG. 2A, the UAVMCS may get control of the UAV 102 when the UAV approaches the UAVMCS by a certain distance. As shown in FIG. 2A, the UAVMCS further may exchange data between the UAVMCS, the UAV 102 and the external control system of a device. As shown in FIG. 2A, the UAVMCS may further receive updated configuration information about the UAV 102 movement plan. As shown in FIG. 2A, the UAVMCS may further receive a confirmation for holding control of the UAV 102 from the external control system or a device. As shown in FIG. 2A, the UAVMCS may further switch to the docking with the UAV 102 mode. As shown in FIG. 1A and FIG. 2A, the UAVMCS further may use sensors 105, 106, 205 and 206 to synchronize all sensors, systems, modules of accurate positioning of the UAV 102 with appropriate modules of the UAVMCS. As shown in FIG. 1A and FIG. 2A, the UAVMCS may further manage the UAV 102 approaching the UAVMCS, until the moment the UAV 102 reaches a certain point under the UAVMCS and above the ensuring helipad surface 107, which is fixed by a side bracket 110, but not limited to it. As shown in FIG. 1A and FIG. 2A, the UAVMCS further may lift the UAV 102 inside the UAVMCS until the moment of full electromechanical connection of the upper charging and refueling frame 207 of the UAV 102 with the charging module of the UAVMCS. As shown in FIG. 2A, the UAVMCS may further close the docking housing 202, 203 and 204. FIG. 3A-3B illustrates the closed state of the UAVMCS with UAV 102 inside. The UAVMCS may further send information to the external control system or a device the UAVMCS may further process request, synchronization of all actual parameters of the station with the external control system or a device. the UAVMCS may further exchange data with an external control system or a device for plan of charging, storage, docking out, flying out another flight of the UAV 102. The UAVMCS may further receive a configured plan of the UAV 102 movement from the external control system or a device. the UAVMCS may further receive a configured plan of the UAV 102 movement from the external control system or a device. As shown in FIG. 1A and FIG. 3A-3B, the UAVMCS may switch to the UAV 102 charging and storage mode according to the updated plan. As shown in FIG. 3a-3B, the UAVMCS may perform a charging process using power module 301, conical, but not limited to the shape, bearing surface of the receiving assembly of the docking housing 302 and receiving assembly of the docking housing 303 and the frame for placing sensors. The UAVMCS may further receive incoming information from the external control system or a device and may process request and synchronization of all actual parameters of the UAVMCS with the external control system or a device. The UAVMCS may further exchange data with an external control system or a device for completion of charging, docking, and flying out of the UAV 102. The UAVMCS may further receive a configured plan of the UAV 102 movement from the external control system or a device. As shown in FIG. 1A and FIG. 3A-3B, the UAVMCS may switch to the UAV 102 flying out mode. The UAVMCS further may scan the surrounding environment to ensure safe a flight out for the UAV 102. As shown in FIG. 3A-3B, the UAVMCS may further use control module 304 to open the docking housing 305 to allow the UAV 102 to fly out. The UAVMCS may further synchronize all sensors, systems, modules of accurate positioning of the UAV 102 with appropriate modules in the station. As shown in FIG. 1A, FIG. 2A, and FIG. 3 the UAVMCS may further manage the flying out and lowering of the UAV 102 within the UAVMCS until the moment of full electromechanical disconnection of the upper part of the UAV docking charging and refueling frame 207, and until the moment the UAV 102 reaches a certain point under the docking housing unit 101 and above the ensuring helipad surface 107 fixed by the side bracket 110, but not limited to this way of mounting. As shown in FIG. 3A-3B, the UAVMCS further may send visual, radio, and other signals to the surrounding environment for the UAV 102 to fly out. As shown in FIG. 3A-3B, the UAVMCS further may perform mutual data exchange with the external control system or a device. The UAVMCS may further receive updated configuration information about the UAV 102 movement plan. The UAVMCS may further manage the UAV 102 flying out from the UAVMCS, until the UAV 102 reaches a certain distance. The UAVMCS may further pass control of the UAV 102 to the external control system or a device.

FIGS. 1-10, the corresponding text, and the above-discussed examples provide a number of different methods, systems, and devices for autonomously docking a UAV 102. In addition to the foregoing, embodiments can also be described in terms of flowcharts comprising actions and steps in a method to accomplish a particular result. For example, FIGS. 11A-11B-11C may be performed with more or fewer steps/actions or the steps/actions may be performed in differing orders. Additionally, the steps/actions described herein may be repeated or performed in parallel with one another or in parallel with different instances of the same or similar steps/actions.

FIGS. 11A-11B-11C illustrate a flowchart of one method. For example, the method can be the autonomous docking a UAV 102 on a the UAVMCS. In one or more embodiments, each step of the method is performed by an autonomous docking system 1000 including a UAV 102 and a the UAVMCS. For example, a UAV 102 can perform one or more steps of the method. Additionally, or alternatively, a the UAVMCS can perform one or more steps of the method. In one or more embodiments, the autonomous docking system 1000 performs one or more steps in accordance with computer-executable instructions and hardware installed on the UAVMCS and/or UAV 102.

As shown in FIGS. 11A-11B-11C, the method can include a process for docking a UAV 102 within the UAVMCS. For example, the method includes an act of guiding a UAV 102 to a vertical space under a docking housing of the UAVMCS. In one or more embodiments, guiding the UAV 102 to the vertical space under the docking housing involves flying the UAV 102 toward the UAVMCS until the UAV 102 is within a threshold distance to the UAVMCS. Additionally, guiding the UAV 102 to the vertical space under the docking housing can involve guiding the UAV 102 until some or the entire docking base of the UAV 102 is positioned vertically under the opening of the docking housing within the UAVMCS. Further, in one or more embodiments, the method includes detecting that a battery on the UAV 102 is low and/or receiving a user input (e.g., a command) instructing the UAV 102 to dock. In one or more embodiments, the act of guiding the UAV 102 toward the UAVMCS is performed in response to detecting that the battery is low and/or in response to receiving a user input.

The method also includes the act of lowering the UAV 102 within a docking housing of the UAVMCS. In one or more embodiments, the act of lowering the UAV 102 within the docking housing involves lowering the UAV 102 toward the UAVMCS until a UAV docking charging and refueling frame 207 makes contact with the receiving assembly of the docking housing 302 of the UAVMCS. In one or more embodiments, lowering the UAV 102 involves causing one or more rotors to change angles and/or speed and cause the UAV 102 to ascend to under the docking housing toward an opening of the docking housing 204 shaped to receive the UAV docking charging and refueling frame 207. Additionally, in one or more embodiments, lowering the UAV 102 involves lowering the UAV 102 until a UAV charging contact and/or UAV docking charging and refueling frame comes into contact with a receiving assembly of the docking housing at any point to an opening of the docking housing. Further, in one or more embodiments, the UAV 102 and/or the UAVMCS can detect that the UAV 102 and/or portion of the UAV 102 (e.g., the UAV docking charging and refueling frame 207) has entered an opening of the docking housing of the UAVMCS.

The method also includes an act of aligning the UAV 102 within the docking housing of the UAVMCS. In particular, the act of aligning the UAV 102 within the docking housing can involve causing a UAV docking charging and refueling frame 207 to contact a docking housing of the UAVMCS as the UAV 102 rises into the UAVMCS. As the UAV 102 enters the docking housing of the UAVMCS, contact between the UAV docking charging and refueling frame 207 and the docking housing of the UAVMCS causes the UAV 102 to self-align within the docking housing of the UAVMCS.

As mentioned above, one or more embodiments of the docking housing of the UAVMCS and the UAV docking charging and refueling frame 207 may have complementary shapes. As such, one or more embodiments of aligning the UAV 102 within the docking housing involves fitting the UAV docking charging and refueling frame 207 within the complementary shaped docking housing of the UAVMCS.

Additionally, while not shown in FIGS. 11A-11B-11C, the method can include an act of detecting that one or more charging contacts on the UAV 102 are coupled to one or more the UAVMCS charging contacts on the UAVMCS. Additionally, in response to detecting that the charging contacts on the UAV are coupled to the UAV charging contacts, the method can include an act of charging a battery on the UAV 102. In particular, an act of charging the battery can involve applying a charge across nodes of the battery via the charging contacts on the UAV and the UAVMCS charging contacts and causing the battery to charge when the UAV 102 is docked and successfully aligned within the UAV docking charging and refueling frame 207.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes solid state drives (“SSDs”) (e.g., based on RAM), flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). Thus, it should be understood that non-transitory computer-readable storage media (devices) could be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological actions, it is to be understood that the subject matter defined in the appended claims is not necessarily limited to the described features or actions described above. Rather, the described features and actions are disclosed as example forms of implementing the claims.

As an example, the exemplary computing device can be configured to perform a process for autonomously docking a UAV 102. Additionally, the computing device can be configured to perform one or more steps of the method described above in connection with FIGS. 11A-11B-11C. The computing device can comprise a processor, a memory, a storage device, an I/O interface, and a communication interface, which may be communicatively coupled by way of a communication module 1014. Additional or alternative components may be used in other embodiments.

In one or more embodiments, the processor includes hardware for executing instructions, such as those making up a computer program. As an example, and not by way of limitation, to execute instructions, the processor may retrieve the instructions from an internal register, an internal cache, the memory, or the storage device and decode and execute them. In one or more embodiments, the processor may include one or more internal caches for data, instructions, or addresses. As an example, and not by way of limitation, the processor may include one or more instruction caches, one or more data caches, and one or more translation lookaside buffers (TLBs). Instructions in the instruction caches may be copies of instructions in the memory or the storage.

The memory may be used for storing data, metadata, and programs for execution by the processor(s). The memory may include one or more of volatile and non-volatile memories, such as a solid-state disk (“SSD”), flash, Phase Change Memory (“PCM”), or other types of data storage. The memory may be internal or distributed memory.

The storage device includes storage for storing data or instructions. As an example, and not by way of limitation, a storage device can comprise a non-transitory storage medium described above. The storage device may include a hard disk drive (“HDD”), a flash memory, an optical disc, magnetic tape, or a Universal Serial Bus (“USB”) drive or a combination of two or more of these. The storage device may include removable or non-removable (or fixed) media, where appropriate. The storage device may be internal or external to the computing device. In one or more embodiments, the storage device is non-volatile, solid-state memory. Where appropriate, this ROM may be mask-programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface allows a user to provide input to, receive output from, and otherwise transfer data to and receive data from the computing device. The I/O interface may include a mouse, a keypad or a keyboard, a touch screen, a camera, an optical scanner, network interface, modem, AR, other known I/O devices or a combination of such I/O interfaces. The I/O interface may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface is configured to provide graphical data to a display for presentation to a user. The graphical data may be representative of one or more graphical user interfaces and/or any other graphical content as may serve a particular implementation.

The communication interface can include hardware, software, or both. In any event, the communication module 1014 can provide one or more interfaces for communication (such as, for example, packet-based communication) between the computing device and one or more other computing devices or networks. As an example, and not by way of limitation, the communication interface may include a network interface controller (“NIC”) or network adapter for communicating with an Ethernet or other wire-based network or a wireless NIC (“WNIC”) or wireless adapter for communicating with a wireless network, such as a WI-FI. In some examples, the communication module 1014 can be in constant communication with the UAVs 102 via a cellular, radio frequency (RF), and other suitable long-range wireless connection. In some examples, the communication module 1014 can also comprise via either the internet connection or a dedicated connection, with local or regional package handling center or central facility. The internet connection can enable the UAV general controller 1006 to retrieve weather and package data, for example, to enable the system 1000 to route UAVs 102 in an efficient manner, while avoiding bad weather when possible. In some examples, the UAVMCS general controller can adjust UAVs' route dynamically based on, for example, the load weight and/or size, changes in weather, package priority, or traffic from other UAVs or other air traffic.

Additionally, or alternatively, the communication module 1014 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication module 1014 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication module 1014 may include hardware, software, or both that couple components of the computing module 1022 to each other. As an example and not by way of limitation, the communication module 1014 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

In some examples, the system can also comprise additional features for improved aesthetics, functionality, and profitability. In some examples, the system can comprise signage. This can include, for example, banners, signs, and display screens. In some examples, the signage can comprise advertising to generate additional revenue for the provider. In other examples, the signage can provide information, such as the location number or GPS coordinates of the docking station to enable users to locate packages.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/actions or the steps/actions may be performed in differing orders. Additionally, the steps/actions described herein may be repeated or performed in parallel with one another or in parallel with different instances of the same or similar steps/actions. The scope of the present application is, therefore, indicated by the appended claims rather than by the foregoing description. All changes that come within the meaning and range of equivalency of the claims are to be embraced within their scope.

While several possible examples are disclosed above, examples of the present disclosure are not so limited. For instance, while a system of UAVMCSs for UAVs to deliver packages is disclosed, other UAV tasks could be selected without departing from the spirit of the disclosure. In addition, the location and configuration used for various features of examples of the present disclosure such as, for example, the location of the package transfer system and lockers, the number and type of services provided by the UAVMCS, and the locations and configurations of the UAVMCS can be varied according to a particular neighborhood or application that requires a slight variation due to, for example, size or construction covenants, the type of UAV required, or weight or power constraints. Such changes are intended to be embraced within the scope of this disclosure.

The specific configurations, choice of materials, and the size and shape of various elements can be varied according to particular design specifications or constraints requiring a device, system, or method constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

What is claimed is:

1. A multi-purpose station for docking, charging, and refueling an unmanned aerial vehicle comprising:
a docking housing unit having a charging port;
a power supply;
at least one sensor;
a control module comprising a processor and a memory;
a locking and charging mechanism; and
a mounting bracket for attaching.

2. The station of claim 1, wherein the shape of the docking housing unit is a hexagonal cylinder, pyramid, triangle pyramid, or cylinder.

3. The station of claim 1, wherein the docking housing unit further comprising a GPS unit.

4. The station of claim 1, wherein the station further comprising a protective enclosure positioned on top of the docking housing unit.

5. The station of claim 4, wherein the enclosure is a parasol configured to be in opened or closed position; the enclosure is coupled to an enclosure operation mechanism.

6. The station of claim 5, wherein the docking housing unit further comprising a parasol control module configured to close and open the parasol.

7. The station of claim 4, wherein the enclosure further comprising two or more protective covers configured to move toward each other to cover the docking housing unit or move away from each other to expose the docking housing unit; and wherein the two or more protective covers are coupled to the enclosure operation mechanism.

8. The station of claim 4, wherein the enclosure comprises at least one sensor.

9. The station of claim 1, wherein the docking housing unit further comprising a receiving assembly having at least one sensor.

10. The station of claim 1, wherein the docking housing unit further comprising a cooling and heating module.

11. The station of claim 1, wherein the docking housing unit further comprising a fuel tank.

12. A system for docking, charging, and refueling an unmanned aerial vehicle comprising:
one or more stations of claim 1; and
a charging/docking/refueling frame adapted to be mounted on an unmanned aerial vehicle.

13. The system of claim 12 further comprising a lower suspension mechanism.

14. The system of claim 12 further comprising a helipad having one or more sensors and a helipad mounting holder.

15. The system of claim 12 further comprising a load positioning member.

16. The system of claim 15 further comprising an ID tag.

17. The system of claim 12, wherein the charging/docking/refueling frame comprising a pipe adapted to connect to a fuel tank of the one or more stations.

18. A method for aerial recharging and refueling of an unmanned aerial vehicle, comprising:
providing a station of claim 1;
by using the control module, directing and docking the unmanned aerial vehicle to the station; and
performing at least one of recharging and refueling the unmanned aerial vehicle.

19. The method of claim 18, further comprising the step of turning off the unmanned aerial vehicle after docking has been performed, by using the control module.

20. A method of long-distance cargo transporting by an unmanned aerial vehicle, comprising:
providing the system of claim 13;
picking up cargo using the lower suspension mechanism;
performing at least one of recharging and refueling the unmanned aerial vehicle without landing;
and dropping off cargo at a specified destination using the lower suspension mechanism.
